(19) United States
(12) Patent Application Publication
(10) Pub. No.: US 2026/0099788 A1
(43) Pub. Date: Apr. 9, 2026

(54) SYNCHRONIZED AUTONOMOUS VEHICLE MOTORCADE FOR GROUP TRANSPORTATION

(71) Applicant: HYPRLABS INC., San Francisco, CA (US)

(72) Inventors: Tim KENTLEY-KLAY, San Francisco, CA (US); Nathan Anthony FLACK, Collingwood (AU)

(73) Assignee: HYPRLABS INC., San Francisco, CA (US)

(21) Appl. No.: 19/352,372

(22) Filed: Oct. 7, 2025

Related U.S. Application Data
(60) Provisional application No. 63/704,453, filed on Oct. 7, 2024.
(60) Provisional application No. 63/708,220, filed on Oct. 16, 2024.

(51) Int. Cl. G06Q 10/0631; G05D 1/698; G05D 105/22; G05D 107/13; G05D 109/10; G05D 111/30; G06Q 50/47

(52) U.S. Cl. CPC G06Q 10/06315; G05D 1/6987; G06Q 50/47; G05D 2105/22; G05D 2107/13; G05D 2109/10; G05D 2111/32

(57) ABSTRACT

Systems and methods are disclosed for coordinating multiple autonomous vehicles for group transportation, including a server initializing a motorcade session based on a motorcade formation request and starting a motorcade session, wherein the motorcade session includes coordination of integrated functionality across the autonomous vehicles within the motorcade via communication with a server or via vehicle-to-vehicle communication channels.

### PRIORITY APPLICATION

This application claims the benefit of and priority to U.S. Provisional Application No. 63/708,220 filed 16 Oct. 2024, titled “SYNCHRONIZED AUTONOMOUS VEHICLE MOTORCADE FOR GROUP TRANSPORTATION” (Atty. Docket No. HYPR 1003-2) and to U.S. Provisional Application No. 63/704,453 filed 7 Oct. 2024, titled “SYNCHRONIZED AUTONOMOUS VEHICLE MOTORCADE FOR GROUP TRANSPORTATION” (Atty. Docket No. HYPR 1003-1).

### RELATED CASES

This application is related to contemporaneously filed International PCT Application No. ______, filed 7 Oct. 2025 titled “SYNCHRONIZED AUTONOMOUS VEHICLE MOTORCADE FOR GROUP TRANSPORTATION” (Atty Docket No. HYPR1003-4WO), which is incorporated by reference for all purposes.

This application is also related to the following commonly owned applications, all of which are incorporated by reference for all purposes:

U.S. patent application Ser. No. 18/759,880, filed 29 Jun. 2024, titled “Scalable Training and Validation for an End-To-End Autonomous Driving Model”(Atty. Docket No. HYPR 1001-1);

PCT Application No. PCT/US2024/036289, filed 31 May 2024, titled “System and Methods For Providing Driver Assistance Alerts Using an End-To-End Artificially Intelligent Collision Avoidance System and Advanced Driver Assistance Systems” (Atty Docket No. HYPR 1002-2WO);

U.S. patent application Ser. No. 18/431,827, filed 2 Feb. 2024, titled “Multi-Functional Inventory Storage and Delivery System” (Atty. Docket No. HYPR 1000-2); and

U.S. Provisional Application 63/443,342 filed 3 Feb. 2023, titled “Multi-Functional Inventory Storage and Delivery System” (Atty. Docket No. HYPR 1000-1).

### FIELD OF THE TECHNOLOGY DISCLOSED

The technology disclosed relates to end-to-end neural networks configured for autonomous and semi-autonomous driving. In particular, the technology disclosed relates to a scalable method and apparatus for coordinated control of integrated features across a fleet or motorcade of autonomous or semi-autonomous vehicles.

### BACKGROUND

The technology disclosed relates to coordinated control of autonomous or semi-autonomous vehicles, including coordinated control of navigation, communication, and multimedia features across a fleet or motorcade of autonomous vehicles. While modern autonomous vehicle systems can individually perceive their surroundings and generate actuation signals based on advanced sensor inputs, most existing deployments treat vehicles as isolated nodes. This separation limits opportunities to enhance transportation efficiency and user experience when multiple vehicles are traveling toward related destinations or operating under common parameters. Conventional ride-sharing and fleet management services typically optimize vehicle dispatch on an individual basis without leveraging real-time, or near real-time, data from other vehicles in the fleet. This approach can result in staggered arrivals, underutilized capacity, and fragmented user interaction for groups that desire a coordinated travel experience. Further, without a centralized framework to manage communications, multimedia, or synchronized navigation, each vehicle must independently handle user preferences and routing, reducing the potential benefits of scalable, data-driven coordination.

An opportunity arises to implement an integrated server-based architecture that treats multiple autonomous vehicles as a dynamic, adaptable unit rather than isolated endpoints. By coordinating navigation, communication between vehicles and between passengers, and multimedia services across the group, the technology disclosed can improve consistency in arrival times, enhance passenger engagement, and increase the overall efficiency of autonomous vehicle networks. This integrated approach allows data from one vehicle to inform the operation of others, resulting in a more robust and cohesive group transportation experience.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 is a block diagram of a motorcade system.

FIG. 2 is a block diagram of a motorcade server.

FIG. 3 is a block diagram of an autonomous vehicle.

FIG. 4 is an architectural-level schematic of an end-to-end conditional imitation learning model for autonomous driving.

FIG. 5 is a message flow diagram for motorcade initialization.

FIGS. 6, 7, and 8 illustrate respective example implementations including a server initializing a motorcade session from a motorcade formation request.

FIGS. 9A, 9B, and 9C show respective message flow diagrams for coordinated control of navigation features across a motorcade.

FIG. 10 illustrates an example implementation including coordinated control of updated navigation and scheduling parameters across a motorcade.

FIGS. 11A, 11B, 11C, 11D, and 11E show respective message flow diagrams for coordinated updates across a motorcade session.

FIG. 12 illustrates an example implementation including synchronized travel of multiple autonomous vehicles within a coordinated motorcade.

FIG. 13 is a message flow diagram of an integrated communication.

FIG. 14 is a message flow diagram for an integrated multimedia function.

FIG. 15 illustrates a computer system that can be used to implement the technology disclosed, in accordance with certain implementations of the present disclosure.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

Modern transportation systems increasingly rely on autonomous vehicles. Although such systems have significantly advanced in the ability to process sensor data through end-to-end (E2E) autonomous driving models, existing deployments are optimized for single-vehicle operation. Each autonomous vehicle can independently determine its route and driving behavior based on local data streams. While this independence provides flexibility for individual travel, it creates a barrier to group coordination, limiting the ability to synchronize multiple vehicles toward a shared transportation objective. As ride-sharing, fleet management, and on-demand mobility services expand, users are expected to request transportation experiences that accommodate groups of participants traveling together. These services will involve multiple vehicles operating under separate control instances, resulting in inconsistent arrival times, redundant route selections, and inefficient use of available fleet resources. The absence of coordinated control among autonomous vehicles will limit opportunities for shared entertainment or communication among distributed participants, diminishing the social and experiential aspects of group travel.

Conventional fleet systems rely on static dispatch logic that plans routes from initial booking data without adapting to environmental changes or user updates. When delays, closures, or congestion occur, re-routing typically happens per vehicle rather than across the fleet, causing vehicles bound for the same destination to become unsynchronized and disrupting shared schedules or activities. These challenges reflect a broader limitation in fleet management and ride-sharing frameworks: the absence of a unified control structure capable of linking the operational states of multiple vehicles. Without centralized coordination, information from one vehicle cannot easily improve another's performance or maintain temporal alignment across groups in transit. Existing ride-sharing frameworks dependent on human drivers and fixed routes further lack responsiveness for flexible group coordination. Mid-trip destination changes or synchronized arrivals often require separate bookings and driver communication, creating inefficiency. The technology disclosed supports collective itinerary updates, enabling participants to modify destinations or communicate changes across the motorcade with minimal disruption.

In some implementations, the technology disclosed extends beyond simple convoyed vehicle spacing by treating an organized group of autonomous vehicles as a motorcade capable of functioning as a unified entity, substituting for the function of a minivan, bus, or other shared transport without requiring passengers to physically occupy the same vehicle. Participants may travel in separate vehicles while remaining virtually connected through synchronized navigation, communication, and multimedia services managed by a central controller. Riders in each vehicle can exchange messages, share audio or video, or coordinate entertainment selections to create a continuous, shared experience across the motorcade.

The technology disclosed offers an improved solution to the coordination and tractability challenges in fleet management and ride-sharing services, including a server-based coordination framework configured to manage a plurality of autonomous vehicles within a dynamically formed motorcade. The server can receive a motorcade formation request from a user that specifies parameters such as a quantity of participants (or a quantity of vehicles), one or more pick-up locations, and a destination location. The technology disclosed can also include a rendezvous location, or link-up location, prior to the destination location. Subsequently, the server initializes a motorcade session based on the motorcade formation request, including a quantity of autonomous vehicles for use in the motorcade, assignments corresponding to the vehicles and respective pick-up locations, and a generated transportation itinerary that includes driving routes and estimated travel times for each route. Within a motorcade session, the server establishes secure communication links with the autonomous vehicles to exchange navigation and coordination data for functionality integration during the motorcade session.

Integrated communication and media features provide continuity between vehicles, transforming distributed participants into a connected cohort. This framework enables autonomous vehicle fleets to operate not as independent units, but as coordinated systems capable of adapting collectively to real-world conditions and user preferences. The conversation now turns to an overview of terminology used to describe the technology disclosed for the sake of clarity, followed by an introduction of the disclosed system, according to some implementations.

### Terminology

For clarity and completeness, certain terms used herein are introduced below. The terminology and corresponding examples are provided to facilitate consistent interpretation throughout the description and claims. Unless expressly stated otherwise, the terms are not intended to be limiting and may encompass other variations, equivalents, or analogous structures apparent to those skilled in the art. The examples provided to elaborate upon any particular term are illustrative and non-limiting. As used herein, the term “autonomous vehicle” can refer to a vehicle (e.g., car, truck, transporter robot, bus, etc.) that includes one or more systems configured to perform driving operations with reduced or minimal human input. For conciseness, “autonomous” may be used herein as an umbrella term that encompasses vehicles that are fully autonomous, semi-autonomous, or partially autonomous, including vehicles that operate under human supervision or intervention. Put differently, any implementation described with respect to an autonomous vehicle is understood to be similarly applicable to a semi-autonomous or partially autonomous vehicle, even if a semi-autonomous or partially autonomous implementation is not explicitly described for the sake of conciseness. An autonomous vehicle may rely on local onboard control logic, onboard control logic associated with another autonomous vehicle connected via V2V communication, remote coordination from a server, or a combination of both. In some implementations, certain features or functions of the vehicle can be partially automated through server control to achieve coordination with other vehicles, such as synchronizing acceleration or adjusting route timing, while still operating without continuous human input. “Autonomous” as used herein further includes vehicles configured to operate autonomously in one mode of operation while another mode of operation may allow for the vehicle to accept human input related to one or more vehicle operations. For example, a vehicle may operate in a fully autonomous mode during group coordination, in a supervised or “shadow” mode when learning from a human driver, and/or under a manual override condition when user input is permitted or required for safety (e.g., implementations involving restrictions on autonomous driving in order to comply with law or regulation). The vehicle may dynamically transition between these modes in response to environmental or system conditions. Autonomous vehicles may be referred to simply as “vehicles” with respect to certain implementations of the technology disclosed.

The autonomous vehicles described herein can perform end-to-end processing of data collected by a camera or sensor connected to/integrated within the vehicle. As used herein, the term “camera system” can refer to any combination of data-acquisition devices mounted on or communicatively connected to a vehicle for perceiving its surroundings. Non-limiting examples include images and/or video feeds collected by one or more external 2D or 3D cameras, sensor data collected from a LiDAR array (e.g., detection of road features and proximity data), radar sensor(s) for collision avoidance, and/or an environmental sensor package configured to monitor traffic lights and weather conditions. A camera/sensor system can provide image, depth, or positional data used by the vehicle or a coordinating server for navigation and environment interpretation. The autonomous vehicles described herein can further leverage an accelerometer and a GNSS feed. For conciseness, implementations of the technology disclosed frequently refer to the data collection systems leveraged for collection of input data for the E2E driving model as “camera systems,” but this term is not intended to limit the data collection features strictly to cameras. Similarly, reference to a “sensor” may refer to a camera, a 3D sensor, a LiDAR sensor, and so on.

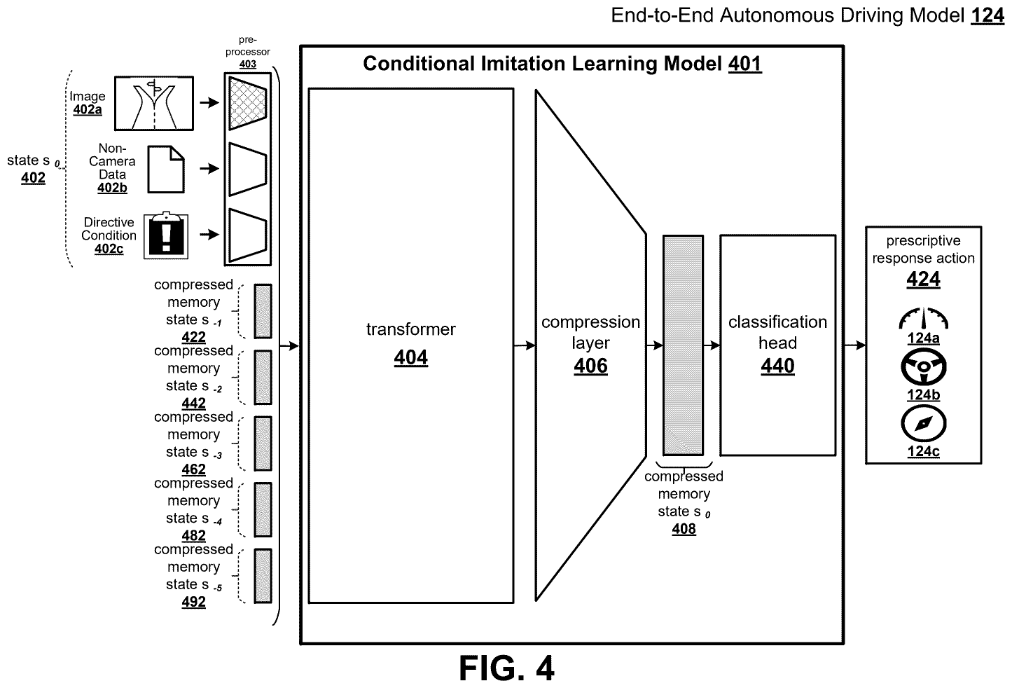

As used herein, the term “end-to-end autonomous driving model” (used synonymously with “E2E model,” “autonomous driving model,” and so on) can refer to a computational model configured to generate actuation control signals from input sensor and route data. The model can be machine-learned, algorithmic, or rule-based, trained on real-world or simulated data, such as a deep learning model like a transformer. An E2E model may process input data to control steering and braking, receive GNSS and map data to update route predictions, or output acceleration and turn commands to an actuation interface, discussed further with respect to FIG. 4 below.

As used herein, the term “driving data” can refer to sensor, perception, and/or environmental data used by an E2E model to determine actuation or navigation behavior. Driving data can include, e.g., video feeds and/or LiDAR feeds, GNSS coordinates and speed readings (e.g., accelerometer data) used to estimate position and velocity, or inertial and steering-angle measurements used for motion control. Driving data can be generated locally by the vehicle or received from other vehicles or systems to inform operation. More generally, the term “vehicle data” is used herein to encapsulate not only driving data, but operational data associated with one or more vehicles, such as the vehicles within a motorcade, including but not limited to driving data (e.g., GNSS data, video data, LiDAR data), vehicle health data (e.g., fuel and/or battery status, tire or brake status, etc.), communication logs (e.g., back-end communication between the autonomous vehicles, server, and other system components as well as user communication between passengers), or navigation updates. Vehicle data can be used to coordinate navigation, synchronize itineraries, or stream multimedia content across a motorcade.

As used herein, the term “motorcade” can refer to a group of two or more autonomous vehicles that operate under coordinated control toward one or more destinations. Vehicles in a motorcade may be physically proximate, spaced apart, or traveling along distinct routes while remaining logically linked through shared data exchange or itinerary management. “Physically proximate” can refer to vehicles separated by distances small enough to maintain line-of-sight or sensor-based detection, such as within about 1 meter to 50 meters, 5 meters to 100 meters, or any range bounded by these values. In highway or urban conditions, proximate operation may correspond to vehicles within one to three car lengths or within a time headway of less than two sec. at prevailing speeds. “Spaced apart” can refer to separations larger than those used for proximate travel yet still coordinated within a shared motorcade session, such as vehicles located within 0.5 kilometers, 1 kilometer, or 5 kilometers of one another, or within a 5-min. travel window based on dynamic routing. In some implementations, vehicles in a motorcade may be located across different traffic corridors, road segments, or parallel routes but remain logically synchronized through shared navigation, communication, or multimedia control. “Motorcade” may be used analogously to “fleet,” “fleet subset,” “convoy,” or “coordinated vehicle group.”

As used herein, the term “transportation itinerary” can refer to data representing a pre-determined, and optionally adaptive/dynamically-updated, set of travel parameters for one or more vehicles. The transportation itinerary can include driving route(s), estimated travel times corresponding to respective driving routes or leg(s) of driving routes, arrival, departure, pick-up or drop-off time(s), intermediate stop(s), or assignments of respective sets of one or more autonomous vehicles to a specific pick-up time, destination location, and/or driving route. A transportation itinerary may include the route and estimated arrival times for a group of vehicles traveling to a concert, updated departure times reflecting a traffic delay, or new destination data following a user request to add an intermediate stop.

As used herein, the term “leg” can refer to any segment, part, or portion of a driving route that extends between two defined locations within a transportation itinerary. A leg may extend, for example, between a 1^{st} point and a 2^{nd} point, between a pick-up location and an intermediate stop, or between an intermediate destination and a final destination. The term can be used synonymously with “segment,” “portion,” “route section,” or “part of a driving route,” and may include any path traveled between two nodes of interest, regardless of route geometry or distance. In various implementations, a transportation itinerary may include one or more legs, each defined by its own parameters such as departure and arrival locations, estimated travel duration, and associated vehicle assignments. Locations referenced in relation to a leg can include a “destination location,” “destination,” “final destination,” “intermediate destination,” “stop,” or “intermediate stop,” and such terms may be used interchangeably unless context requires otherwise. For example, a particular driving route within a transportation itinerary may include a 1^{st} leg from a pick-up location to a 1^{st} destination location (e.g., an intermediate stop), a 2^{nd} leg from the 1^{st} destination location to a 2^{nd} destination location (e.g., a 1^{st} intermediate stop to a 2^{nd} intermediate stop), and a 2^{rd} leg from the 2^{nd} destination location to a 2^{rd} destination location (e.g., the 2^{nd} intermediate stop to the final destination location). Generally, the term “final destination” refers to a location that concludes the trip prior to the server terminating the motorcade session, or, at least, terminating the connection to a particular autonomous vehicle within a motorcade session as the vehicle will no longer be used for any additional pick-ups or drop-offs within the motorcade session. The numbering of locations, such as a 1^{st} destination, 1^{st} pick-up location, 1^{st} travel time, and so on, is provided solely for distinction among multiple references and does not necessarily indicate sequence, priority, or chronological order. A leg can therefore represent any continuous or discontinuous travel segment within an itinerary, including those traversed sequentially, concurrently, or in a dynamically reordered fashion based on updated routing conditions or user inputs.

As used herein, the term “coordinated control” can refer to an orchestration or management of one or more integrated functions across at least two vehicles in a motorcade based on shared or exchanged data. Coordinated control may include centralized management by a server or distributed coordination among vehicles. Coordinated control may adjust navigation routes for all vehicles based on updated traffic data, propagate a user's message or media selection to every vehicle in the motorcade, or modify lighting display parameters simultaneously across the fleet. As used herein, the term “integrated function” can refer to a feature, a capability, and/or a service implemented across two or more vehicles within a motorcade, such as navigation, communication, or multimedia presentation. An integrated function can include synchronized route planning between vehicles, coordinated video streaming for participants across cars, or shared communication routing for group messages. The term encompasses functions centrally facilitated by the server or jointly executed by the vehicles. As used herein, the term “feature” or “function” can refer to a discrete capability, operation, or service implemented by one or more system components. Examples include a feature for initiating or modifying a transportation itinerary, a function that establishes secure communication links between vehicles, or a multimedia control operation for selecting or synchronizing content. Such vehicle operation terms may be used synonymously and are not restricted to software-based or hardware-based implementations.

As used herein, the term “end user application” or “end user app” can refer to a software or hardware interface operated by a user to interact with the system. The application may allow users to request, join, or manage a motorcade, update destinations, send communications, and/or interact with entertainment functions. Examples can include a mobile app that displays synchronized arrival times, a tablet interface allowing passengers to send chat messages between vehicles, a user interface integrated within the interior of an autonomous vehicle, a remote control device (e.g., remote controllers, gaming controllers, keyboards, touch-screen displays, and so on) accessible to a user (e.g., a participant in the motorcade, also referred to as a passenger, or another individual associated with the management or operation of the motorcade service), and/or a web-based interface permitting passengers and/or fleet administrators to modify motorcade sessions.

As used herein, the term “media content” can refer to data suitable for presentation through a user interface of a vehicle or other user device, such as a smart phone, tablet, laptop, etc. The terms “multimedia,” “media,” “content,” “content stream,” etc. may encompass, without limitation, audio, video, image, or interactive materials. Examples include synchronized playback of a music playlist across vehicles, streaming of a shared video feed or live event, and interactive games or polls conducted between participants in different vehicles. Media content may originate from a participant, from 2^{rd}-party sources, or from system-provided content libraries. As used herein, the term “lighting display parameter” can refer to any control data defining visual characteristics of a vehicle's lighting, including color, brightness, timing, duration, or animation pattern. Lighting display parameters can coordinate exterior lighting across vehicles to display a unified visual pattern, adjust interior lighting to match the rhythm of shared music playback, or modify brightness in response to proximity or environmental conditions. The term can include internal or external displays used for aesthetic, communicative, or safety purposes.

As used herein, the term “synchronized” can refer to alignment or coordination among vehicles, operations, or data streams such that they remain temporally or logically consistent within an acceptable tolerance. Synchronization may be absolute or relative, and different implementations may define synchronization differently. Synchronization may occur exactly simultaneously across vehicles, may be maintained within a delay of less than one, three, or five sec., or may maintain alignment within a predefined time window such as ±30 sec., ±1 min., ±5 min., or any range bounded by these values. In some cases, synchronization can be relative, such as maintaining an arrival time within ±10 percent of an original estimate or within a few sec. of another vehicle's arrival. As used herein, the term “real time” (or “near real time”) can refer to communication, processing, and/or control executed with latency that is sufficiently low as measured by ability to maintain effective coordination during ongoing operation. The degree of real-time performance may vary by implementation. Real-time operation can include latency less than one 2^{nd} in a navigation control loop, latency less than three sec. in multimedia synchronization, or latency less than five sec. in user message propagation. The term may further encompass near-real-time operation where minor latency does not materially disrupt coordinated behavior.

As used herein, the term “time window” can refer to a range of permissible differences in timing between related events such as arrivals, departures, or data updates. A time window can be defined in absolute or relative terms. A time window may allow arrival times within 30 sec., 1 min., 3 min., or 5 min. relative to another autonomous vehicle (or an inclusive range bound by any two of these values), specify a synchronization tolerance of 5 min., 10 min., or 15 min. (or an inclusive range bound by any two of these values) during long-distance travel, or define a variable interval based on travel duration or dynamic conditions. The time window may be preconfigured, adaptive, or determined by user input. As used herein, the term “delay” can refer to a temporal offset between an expected and actual event time, including latency in data transmission, processing, or travel completion. Delay may represent additional time caused by traffic, correspond to network latency in transmitting media content, or indicate deferred synchronization due to user confirmation requirements. Delay values can be expressed as absolute durations or relative deviations.

As used herein, the term “pick-up time” can refer to a designated or dynamically determined time at which a participant/passenger, or group thereof, is scheduled to enter or be collected by a vehicle. Similarly, a pick-up time can refer to the time that an autonomous vehicle is expected to arrive at a particular pick-up location. A pick-up time can be determined by the server, by a participant through an end user application, or through coordination among multiple vehicles in a motorcade. For example, a pick-up time may represent the start of a journey from a 1^{st} location for one participant, a scheduled meeting time for a group of riders boarding different vehicles, or an updated boarding time adjusted automatically based on traffic or system delay. A pick-up time may be expressed as an absolute time (e.g., 8:30 a.m.), a relative offset (e.g., 5 min., 10 min., or 15 min. after motorcade formation, or an inclusive range between any two of these values), or as part of a time window (e.g., between 8:25 a.m. and 8:35 a.m.). The term may be used synonymously with “boarding time,” “rider collection time,” or “vehicle dispatch time,” depending on context.

As used herein, the term “arrival time” can refer to a designated or calculated time at which a vehicle is expected or scheduled to reach a particular destination location, intermediate stop, or final destination along a transportation itinerary. An arrival time may correspond to (i) a predicted time of arrival (ETA) determined by navigation data, (ii) an actual time of arrival recorded by the vehicle or the server, and/or (iii) a synchronization target within a motorcade where multiple vehicles are intended to reach their respective destinations within a defined time window. For example, the system may define arrival times for several vehicles such that all reach a concert venue within two min. of one another. Arrival times may be updated dynamically as new driving data becomes available or when itinerary updates occur mid-route.

As used herein, the term “departure time” can refer to a scheduled, predicted, or actual time at which a vehicle begins travel from a particular location toward its next destination or leg of a route. A departure time may correspond to (i) the time at which the vehicle leaves a pick-up location after all participants are boarded, (ii) the moment the vehicle exits a stop or parking location to continue to the next leg, and/or (iii) the coordinated time for multiple vehicles in a motorcade to begin movement from their respective positions. For example, departure times for several vehicles can be offset such that all arrive at the next location simultaneously, or can be adjusted to maintain spacing within a proximate convoy. Departure time may also be used synonymously with “start time” or “movement initiation time,” depending on the context of use.

As used herein, the term “link-up time” can refer to a scheduled, estimated, or dynamically determined time at which two or more vehicles within a motorcade are expected to converge, rendezvous, synchronize, or establish coordinated operation during transit. A link-up time may occur when vehicles departing from separate pick-up locations join along a common route, when one vehicle overtakes another to merge into the group, or when previously separated vehicles reestablish communication or synchronized navigation after temporary divergence. For example, a link-up time may correspond to two vehicles meeting along a highway segment before continuing as a coordinated motorcade, a planned synchronization event during a group trip where one vehicle rejoins after a charging stop, and/or a timing threshold for reestablishing media or communication synchronization following network latency. Link-up time may be represented as an absolute timestamp, a relative duration from the beginning of a trip, or a temporal tolerance (e.g., vehicles are considered linked up if they rejoin within 15, 30, 60, 90, or 120 sec., or an inclusive range bound by any of these values, or within a 0.3, 0.5, 0.8, or 1.0 km proximity threshold or an inclusive range bound by any of these values).

In some implementations, a transportation itinerary may define multiple pick-up, departure, arrival, and link-up times for different legs or participants. These time parameters may be dynamically recalculated by the server or vehicle systems based on environmental data, participant inputs, or coordination requirements. The time parameters may be manually adjusted by a participant of the motorcade or a motorcade administrator authorized to modify motorcade sessions. The numbering of these times (e.g., 1^{st} pick-up time, 2^{nd} arrival time, 2^{rd} link-up time) is provided solely for distinction and does not imply sequential or chronological order unless explicitly indicated.

As used herein, the term “coordinated” can refer to operations or functions that are adjusted or aligned relative to one another based on shared logic or exchanged data. Coordinated functions may include updating multiple itineraries to preserve synchronized arrivals, aligning communication sessions between vehicles, or managing distributed playback of shared media. Coordination may occur proactively or reactively based on situational data. As used herein, the term “integrated” can refer to functions or subsystems that operate jointly or interoperably as part of a larger system. Integrated systems may share data between navigation and communication modules, operate multimedia control logic across several vehicles, or execute server-based and vehicle-based processes concurrently. The discussion now turns to an overview of the disclosed motorcade coordination system, in accordance with some implementations of the technology disclosed.

### System Overview

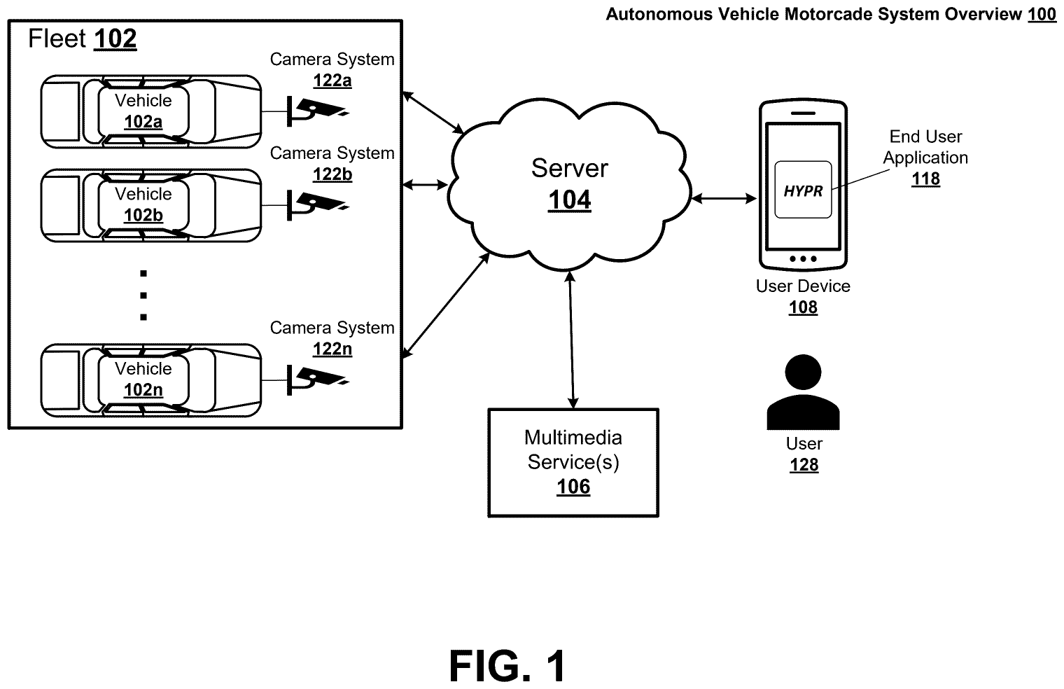

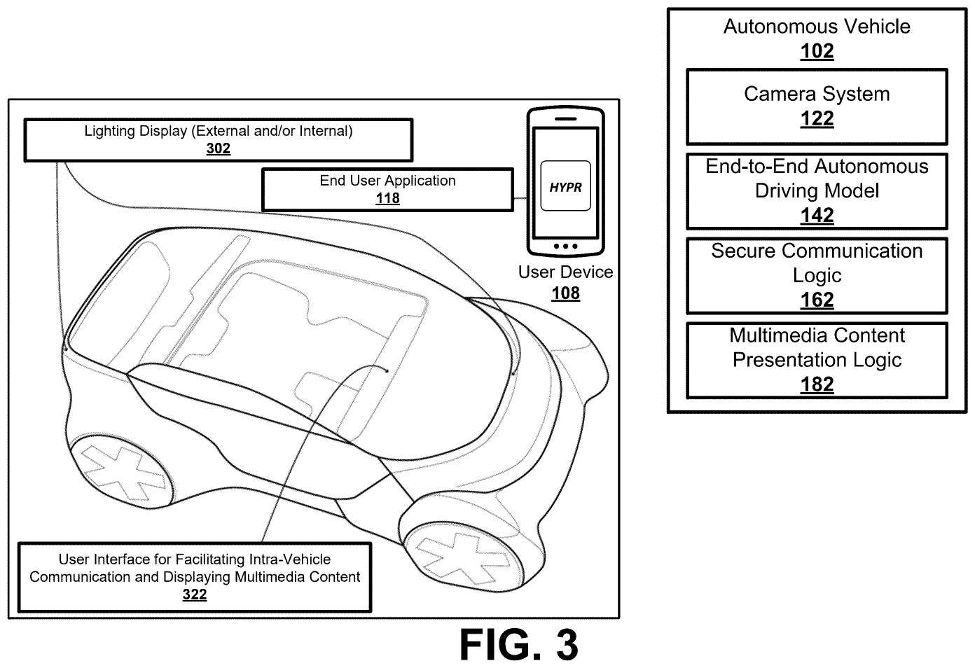

FIG. 1 illustrates a coordinated motorcade system including a fleet 102 of autonomous vehicles (102a, 102b, . . . 102n, each with a respective camera system 122), a motorcade server 104, one or more multimedia services 106, and user device(s) 108 executing an end-user app 118 associated with a user 128. The server 104 coordinates integrated functions of the motorcade, including navigation, communication, and multimedia control, by exchanging data with vehicles 102a-102n and the end-user app 118. In various implementations, vehicles may be assembled from a single origin or from multiple starting positions and treated as a coordinated group while traveling toward one or more destinations. Each vehicle can include in-cabin presentation features (e.g., display and audio systems) to support synchronized communication and shared media across the motorcade, while the camera system 122 provides perception inputs used by on-vehicle control and by server 104 for coordination. Subcomponents of the autonomous vehicles 102 are described in further detail with reference to FIGS. 3-4.

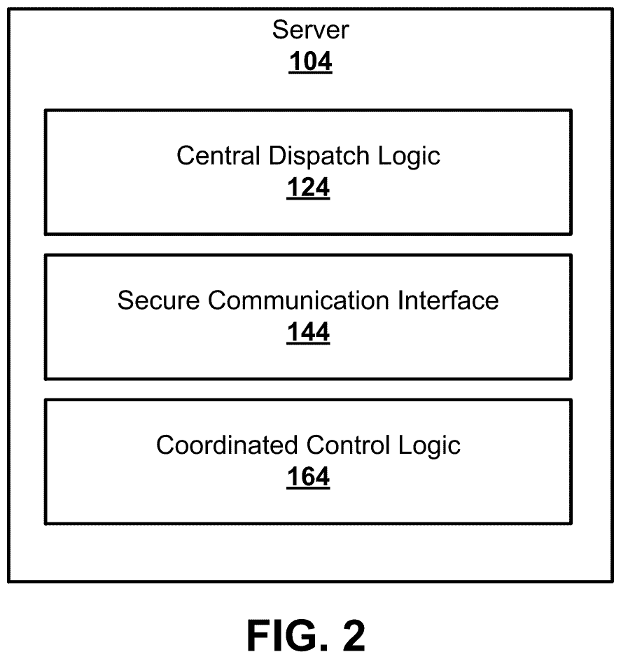

The server 104 can further include, at least, a central dispatch logic 124, a secure communication interface 144, and a coordinated control logic 164, as described in further detail with reference to FIG. 2. The central dispatch logic 124 can receive motorcade formation requests from the end-user app 118 running on user device 108, generate a transportation itinerary (e.g., including pick-up locations, destination locations, intermediate stops, estimated travel times, and time-synchronization parameters for autonomous vehicles 102 within a motorcade), and modify transportation itineraries. The secure communication interface 144 can establish secure communication links (e.g., authenticated and/or encrypted connections) with vehicles 102a-102n and/or with the end-user app 118, supporting bi-directional messaging, itinerary distribution, and media/communication signaling. The coordinated control logic 164 can process vehicle data reported from the fleet 102 including user inputs, location, timing, and sensor-derived updates to maintain alignment of integrated functions. For example, when one vehicle reports a traffic slowdown, the coordinated control logic 164 can direct the central dispatch logic 124 to update the transportation itinerary via 124 and secure communication interface 144 to subsequently transmit revised route, timing, or media-sync parameters to the motorcade such that shared experiences may remain synchronized.

Alternative implementations can execute 124, 144, and 164 on cloud resources, edge nodes, or a combination thereof, and can apply different update intervals depending on function. The server 104 can further interoperate with multimedia service(s)s 106 for content selection, stream distribution, or session state so that group playback across vehicles 102a-102n stays within defined synchronization tolerances while permitting per-vehicle user interface control through the end-user app 118 or in-vehicle interfaces. More specifically, the server 104 can be implemented as one or more computing nodes operating within a centralized cloud environment, distributed edge network, or hybrid configuration. To ensure consistent communication with the fleet 102, the server 104 supports multiple concurrent connection types, including persistent cellular data links (e.g., 4G, 5G), Wi-Fi-based backhaul connections, satellite relay, and low-latency short-range protocols suitable for direct coordination in enabled geographic regions. For example, control messages and synchronization commands may be prioritized on a low-latency cellular or DSRC channel, while large multimedia payloads or diagnostic data may be streamed over Wi-Fi or cached for batch upload through a delayed satellite connection.

The server 104 can maintain temporary data storage and/or persistent data storage to support operational continuity and analytics. Real-time operational data (e.g., driving data, vehicle locations, routing states, and/or link-up progress) may be held accessibly in volatile memory to enable immediate access by the coordinated control logic 164. Persistent logs, including historical itineraries, connection statistics, error events, and/or user interaction data from a user interface or end-user app 118, can be stored within secure databases or object storage systems. These records can allow analysis for system performance optimization (e.g., model training and validation), user data collection, fleet maintenance planning, or compliance auditing. For example, historical travel patterns can be used to predict optimal link-up points for future sessions or to generate anonymized statistics describing synchronization performance across different environments.

In some implementations, data collected by the server 104 may be used to improve routing intelligence and predictive coordination. For instance, aggregated fleet data can identify high-density travel corridors where proactive grouping increases efficiency, or may refine the estimation models used to calculate pick-up, arrival, and/or departure times for subsequent sessions. In some cases, the server 104 can transmit summarized metrics to external systems such as traffic information services or city transportation platforms, enabling coordinated infrastructure-level responses while preserving user privacy (such as through anonymization or encryption layers managed by the secure communication interface 144).

The server 104 can further provide media streaming and content management capabilities through connection with the one or more multimedia service(s) 106. Multimedia services 106 may be integrated within the motorcade services, linked via 2^{rd}-party APIs, etc. The coordinated control logic 164 can act as a media orchestrator, managing group sessions in which multiple vehicles 102 receive synchronized audio or video streams. Depending on available network capacity, the server 104 may employ adaptive bitrate streaming, predictive caching, or pre-buffering strategies to maintain consistent playback among vehicles 102a-102n even under variable conditions. In some implementations, the server 104 can host an internal content repository for curated experiences (e.g., music playlists, lighting sequences, and/or live interaction with interactive graphical activities or games) while the multimedia services 106 provide external streaming or cloud content sources.

In some examples, the server 104 may integrate optional analytics or feedback modules configured to evaluate synchronization performance and user engagement. For instance, the server may log playback synchronization offsets between vehicles, analyze latency trends, and use the data to dynamically adjust synchronization thresholds in future sessions. These feedback mechanisms can enable refinement of the coordinated control logic 164 over time, improving timing precision and user experience consistency across the motorcade.

The fleet of autonomous vehicles 102 includes a plurality of autonomous vehicles 102a-102n, each equipped with onboard computing and communication elements configured to exchange information with the server 104 through the secure communication interface 144. The subcomponents of the autonomous vehicles 102 are described in further detail with respect to FIGS. 3-4. Each vehicle 102a-102n can operate primarily in an independent mode while participating as part of a coordinated group or motorcade during shared sessions. The vehicles may be privately owned, commercially operated, or fleet-managed units dynamically assigned by the server 104 to fulfill transportation itineraries.

Each vehicle can connect with one or more perception subsystems collectively referred to as a camera system 122, which may include video cameras, LiDAR, radar, GNSS receivers, and inertial sensors. The data produced by the camera system 122 can support local control of the corresponding individual autonomous vehicle, as well as intervehicle coordination within the motorcade facilitated by the server 104. An onboard processor can process these inputs through control algorithms or learned driving models (e.g., the E2E model of FIG. 4) to determine steering, accelerator, and braking commands while maintaining communication with the server 104 to receive updates to itinerary, spacing, or media synchronization state.

The onboard computing environment of an autonomous vehicle 102 may further maintain local storage or cache structures for temporarily holding vehicle data, itinerary segments, and synchronization state data received from the server 104. This local caching enables continued operation in the event of transient communication loss. When connectivity resumes, the vehicle can upload accumulated vehicle data (e.g., position logs, media synchronization offsets, and network statistics) back to the server 104 for reintegration. The caching subsystem may use a rolling buffer or write-ahead log so that continuity of itinerary and media synchronization is preserved even during extended offline operation.

The autonomous vehicles 102a-102n may also include a redundant safety controller configured to assume control if communication with the server 104 or the motorcade group is interrupted. In such cases, the vehicle can continue operating autonomously to its current or next assigned waypoint using stored route and timing data until the link with the secure communication interface 144 is re-established. This safety redundancy can be implemented through hardware duplication, sandboxed control software, and/or cloud-assisted shadow mode operation where a local model continues executing pre-authorized commands until a verified update is received.

During active motorcade sessions, vehicles in the fleet 102 may exchange coordination data directly with one another using peer-to-peer links to reduce latency and support localized decision-making. Such peer-to-peer exchanges can occur over dedicated short-range communication (DSRC), 5G, or ad-hoc Wi-Fi channels. For example, vehicles 102a and 102b traveling in proximity may directly exchange relative velocity and braking data to maintain safe spacing, while still reporting summary information to the server 104 for global synchronization. The peer links can also transmit lighting synchronization commands, enabling continuous multi-vehicle illumination patterns even when a vehicle temporarily loses connectivity to the central network.

Each vehicle's onboard system can support multiple operational modes, including a standalone mode and a motorcade mode. In standalone mode, the vehicle operates as a traditional autonomous transport node in transit toward a destination location via a local GNSS feed. In motorcade mode, the vehicle becomes an active participant in a coordinated group, aligning its navigation and/or travel schedule with other vehicles according to parameters determined by the coordinated control logic 164 and/or central dispatch logic 124. Transitions between modes can occur automatically based on proximity detection, itinerary state, and/or instructions from the server 104. For example, a vehicle may switch into motorcade mode upon detecting it has reached a designated link-up time with another vehicle, or exit motorcade mode when departing for an independent destination. The fleet vehicles can also communicate via V2V communications to synchronize integrated functions, particularly when the vehicles are within close proximity to one another.

The fleet vehicles can further support data streaming and multimedia presentation features facilitated by the server 104 and multimedia services 106. The autonomous vehicles 102 within the motorcade can receive synchronized audio or video streams for playback through onboard display and speaker systems. The playback state may be monitored by the server 104, ensuring that all vehicles remain synchronized within a predetermined time synchronization window. In certain implementations, vehicles may also store pre-fetched or predictive buffers of media data, allowing playback to continue seamlessly during momentary network fluctuations.

To maintain operational integrity and participant engagement, each vehicle can log telemetry, diagnostic data, and/or session metadata. Logged data can include, for example, trip identifiers, user identifiers associated with the motorcade session (e.g., via accounts logged into end user applications), synchronization performance, media buffering statistics, and/or sensor fault information. Data can be uploaded periodically to the server 104 for storage in secure repositories, where it can be used to refine coordination models, detect anomalies, or inform predictive maintenance schedules. Certain information, such as aggregated spacing and timing data, may be anonymized for privacy while still contributing to analytical models of system efficiency and performance.

Autonomous vehicles 102a-102n may also support direct integration with infrastructure services, such as charging networks, smart traffic lights, and/or venue access systems. Through the secure communication interface 144, such integrations can allow for automated charging coordination, preferred lane usage for linked fleets, or seamless check-in at destinations that recognize the motorcade as a unified group (e.g., events such as festivals or concerts partnering with the motorcade session). These external connections may operate concurrently with motorcade coordination, ensuring the vehicle's local autonomy and the system-level synchronization remain compatible.

The fleet 102 can include mixed types of vehicles (e.g., passenger cars, vans, or purpose-built pods) each with distinct cabin layouts, display configurations, and sensor packages. The motorcade server 104 can accommodate this heterogeneity by incorporating specific vehicle capabilities at the central dispatch logic 124 and/or coordinated control logic 164. This approach allows for a standardized coordinated control framework capable of operating across diverse vehicle models and manufacturers while maintaining consistent group behavior and participant experience.

The end-user app 118 can be executed on an user device 108 as an interface for interacting with the server 104 and/or an autonomous vehicle 102, as a supplement to/replacement for an in-vehicle user interface device. The user device 108 may include, without limitation, a smartphone, tablet, laptop, and/or wearable computing device (e.g., smart watch). The end-user app 118 may also operate within an in-vehicle console/user interface. console. The end-user app 118 enables users to initiate motorcade sessions, manage itineraries, exchange communications, and access synchronized multimedia features. The end-user app 118 can operate with or without the use of registered user accounts. In one implementation, a user may register an account associated with a user identifier such as an email address, telephone number, username, etc. Account registration can allow the server 104 to maintain a profile including user preferences (e.g., vehicle type, media subscription, privacy level) and historical motorcade participation records stored within a motorcade management database associated with the coordinated control logic 164. In another implementation, the app 118 may allow temporary guest access that enables participation in a specific session without full registration, using session-specific authentication tokens issued by the server 104. In some implementations, the app 118 is accessible via a website interface to allow access without downloading an instance of the application to a mobile device. Each login or session establishment may employ multi-factor authentication to ensure secure access. The secure communication interface 144 can encrypt session credentials and token exchanges to prevent unauthorized access to motorcade data or media streams.

A motorcade session can be initiated through the end-user app 118 by submitting a motorcade formation request specifying one or more pick-up locations, destination locations, intermediate stops, and participant parameters. In some implementations, the user can specify a specific number of vehicles to assign to each particular location. In some implementations, the user can specify a certain class of vehicle for each requested vehicle (or across the full motorcade) based on a quality level (e.g., basic vs. luxury) and/or a cabin capacity. In other implementations, the user can specify a certain quantity of participants (in total and/or per pick-up location) and allow the central dispatch logic 124 to determine an appropriate quantity and distribution of autonomous vehicles 102 for use in the motorcade based on the quantity of participants. Once the server 104, through its central dispatch logic 124, creates a transportation itinerary and assigns vehicles 102a-102n, the initiating user can be designated as a session host or organizer. In some implementations, the host can invite additional participants using various mechanisms managed through the app 118, described further below. In other implementations, only the host can modify or manage the motorcade session via a mobile device, and other participants may use in-vehicle user interfaces. In some implementations, the host may have full authorization rights to modify the motorcade and assign certain rights to other participants (e.g., allowing another participant to also modify the motorcade, another participant to be able to view the motorcade without modification rights, and/or another participant to use intervehicle communication/entertainment features). In one implementation, the host may apply certain access controls to specific participants or vehicles, e.g., to apply a parental control to a particular autonomous vehicle within the motorcade in order to limit media access for children in that particular autonomous vehicle.

Participants can join an active motorcade session in multiple ways. In one example, the initiating user shares an invite link or QR code generated by the server 104, which encodes the session identifier and a limited-duration access token. When a new participant scans the QR code or opens the link within their own instance of the end-user app 118, the server 104 can validate the token through the secure communication interface 144 and associate the new participant with the session. In another example, a participant located physically near one of the vehicles 102a-102n may join by connecting to a localized in-vehicle wireless network (e.g., Wi-Fi or Bluetooth) that advertises session information. The local connection prompts the app 118 to request authorization from the server 104, which confirms participant identity and adds the new user to the group. In shared autonomous vehicles, the end-user app 118 can also permit passengers to join directly from in-vehicle displays by scanning a code displayed on the user interface 322 or entering a short alphanumeric code presented on a vehicle console (e.g., a randomly generated code or a password defined by the initiating user 128). Once joined, the new participant's device can become synchronized with the session state maintained by the server 104, including itinerary progress, communication channels, and/or media playback status.

The end-user app 118 can provide multiple layers of interaction. At a basic level, users can view active itineraries, estimated pick-up and arrival times, and the locations of vehicles 102a-102n in near real time. The interface can display map overlays showing relative spacing of vehicles, current link-up status, and progress toward destinations. Participants can send text, voice, or video messages to other members of the motorcade. Messages are routed through the server 104 via the secure communication interface 144, ensuring that all vehicles and users receive synchronized communication updates. The app 118 can further include media control interfaces allowing users to play, pause, or queue shared media content streamed through the multimedia services 106. These control actions can be relayed through the coordinated control logic 164, which ensures playback state consistency across all vehicles 102a-102n.

In some implementations, the end-user app 118 allows users to modify itinerary parameters while a session is active. For example, a participant may propose adding an intermediate stop, changing a destination, or adjusting the number of vehicles allocated to the group. Such requests are transmitted to the server 104, which can validate or process the request further via coordinated control logic 164, update the itinerary via the central dispatch logic 124, and/or distributes revised route information across the motorcade via secure communication interface 144. The coordinated control logic 164 can facilitate consistency and coordination within the motorcade session, ensuring that resulting timing changes remain within predefined synchronization tolerances so that group cohesion is preserved.

The end-user app 118 may optionally integrate with 2^{rd}-party services (e.g., multimedia services 106) to extend functionality. Examples include mapping and navigation APIs for alternative route visualization, calendar synchronization to automatically populate destination addresses, and/or social or event-planning platforms that facilitate coordinated group travel. The app 118 may also interface with external media streaming providers, enabling participants to link personal accounts and share playlists or media preferences within the motorcade session.

In some examples, the app 118 can access event ticketing or restaurant reservation systems, allowing the server 104 to automatically update the transportation itinerary based on confirmed event start times or reservation windows. Similarly, integration with payment systems can enable cost-sharing or per-seat billing models among participants. These 2^{rd}-party connections are managed through secure application programming interfaces (APIs) or OAuth-based authorization frameworks, ensuring that external data exchange does not compromise the integrity or privacy of the motorcade session. In some implementations, the end-user app 118 maintains local copies of session metadata (e.g., participant identifiers, timing parameters, payment data, and recent communication history) to provide continuity during temporary network loss. When connectivity resumes, the server 104 can reconcile local and central session states using timestamps and event sequence identifiers to prevent duplication or data loss.

Privacy controls are available within the app 118, allowing users to determine the extent of data sharing with the server 104 and other participants. A user may, for instance, disable live location broadcasting while still participating in group communications or allow their identity to appear anonymously within shared media interactions. The secure communication interface 144 enforces encryption of personal data and session communications, while the server 104 enforces data retention and deletion policies consistent with privacy preferences configured through the app 118. In some implementations, the end-user app 118 may include a “guest mode” feature that allows a non-registered participant to temporarily view navigation progress or receive updates about a motorcade without accessing full communication or control functionality. This feature can be useful for event coordinators or external observers wishing to monitor arrival status of a group, or participants that do not have mobile access or cannot create user accounts (e.g., children, international travelers without cellular service, etc.).

The system 100 can operate through a structured data exchange architecture linking the server 104, the fleet 102 of vehicles, the end-user app 118 executed on one or more user devices 108, and any connected multimedia services 106. Server 104 can communicate with autonomous vehicles 102a-102n over the secure communication interface 144, which manages bidirectional data streams across one or more networks. In some implementations, the communication interface can adaptively select among connection types (including cellular, satellite, Wi-Fi, or dedicated short-range radio) based on measured link quality and function priority. For example, control data related to vehicle spacing or safety-critical updates may be routed over a resilient cellular link, while multimedia data may be streamed through broadband Wi-Fi or pre-buffered during high-bandwidth availability. The server 104 can aggregate incoming vehicle data from one or more of the vehicles 102a-102n, such as location, velocity, orientation, and/or sensor health metrics derived from their respective camera systems 122. This data can be further timestamped, logged, and processed by the coordinated control logic 164 to generate a unified model of the motorcade in some implementations. The resulting model can allow the server to issue real-time or near-real-time synchronization commands to each vehicle, adjusting parameters such as route segment timing, spacing intervals, and lighting display cues to preserve coordination.

While the server 104 maintains overarching coordination, vehicles 102a-102n may also exchange data directly through peer communication channels to support local responsiveness and reduce dependence on the central network, e.g., P2P and V2V communication. These links may be established using dedicated short-range communication (DSRC), 5G sidelink, ad-hoc Wi-Fi, or other vehicle-to-vehicle (V2V) protocols. In one implementation, vehicles 102 can leverage peer channels to broadcast compact state packets containing relative position, heading, and speed data. For example, when vehicle 102a decelerates, it can transmit a short-range notification to trailing vehicles 102b and 102c, allowing immediate local adjustments prior to propagation through the server 104. The peer network may also support synchronization of lighting patterns or in-cabin media triggers where minimal latency is desirable. To ensure consistency across the system, each vehicle may periodically verify that its peer-network state remains aligned with the global session state maintained by the server 104 in certain implementations of the technology disclosed. A deviation from the transportation itinerary, such as a timing drift outside the defined time synchronization window or a route deviation forced by traffic flow controls, can prompt automatic recalibration by the coordinated control logic 164, restoring consistency without requiring user intervention.

The end-user app 118 can communicate with the server 104, using encrypted application-layer protocols that operate independently of the vehicle-server communication layer. The secure communication interface 144 can manage both vehicle-server communication and user communication, ensuring consistent encryption and access control policies across channels. Through this interface, user devices 108 can exchange itinerary data, control inputs, and event notifications with the central dispatch logic 124. For example, when a participant modifies a destination in the end-user app 118, the server 104 can evaluate the requested modification for feasibility, update the transportation itinerary, and relay new route and timing parameters to the vehicles 102a-102n through the central dispatch logic 124 and secure communication interface 144. Conversely, when a vehicle reports a timing deviation or environmental hazard, the server 104 can transmit updated information to user devices 108 so that participants see live adjustments reflected in the application interface.

Data from the end-user app 118 may also include control inputs for media playback, communication session initiation, or lighting customization, all of which are routed through the server 104 to ensure synchronization across the motorcade. The server 104 can interface with one or more multimedia services 106 to manage content delivery, buffering, and playback synchronization across the motorcade. This connection may use cloud-based APIs or secure streaming endpoints that provide adaptive bitrate data streams. The coordinated control logic 164 monitors playback progress and alignment between vehicles 102a-102n, issuing micro-adjustments to buffer offsets or playback rate so that all participants experience synchronized content within the active time synchronization window. The multimedia services 106 can also supply metadata, such as lyrics, visualizations, or ambient lighting themes, which are transmitted through the server 104 to the vehicles'multimedia presentation systems. The server 104 may employ predictive prefetching, storing upcoming media segments in the local caches of vehicles 102a-102n based on the itinerary's remaining duration or expected network quality along the route. This approach enables continuous playback during periods of reduced connectivity while still maintaining unified timing when network conditions improve.

The various communication paths in motorcade system 100 can contribute to a multi-tiered feedback loop that maintains operational consistency and enables learning-based system improvement. The server 104 can log coordination data, timing adjustments, and/or user-initiated actions into a structured event log. Vehicles 102a-102n may also record local event histories, including timestamps of received synchronization commands or communication latency statistics. Periodically, these local logs can be uploaded to the server 104 for integration into global session analytics. Analysis of past sessions may be used to train optimal parameters for link-up spacing, enabling the coordinated control logic 164 to adjust thresholds dynamically during future operations.

During an active session, the coordinated control logic 164 can operate as a central arbitration layer to process and evaluate incoming data related to integrated feature(s) across the motorcade. Data from vehicles 102a-102n and user devices 108 flows into the server 104 via the secure communication interface 144, where it is aggregated, analyzed, and/or transformed into control data via the coordinated control logic 164. The updated data and/or controlled data can then be transmitted back through the secure communication interface 144 (potentially after further processing via the central dispatch logic 124) to the vehicles 102 and/or user devices 108, closing the control loop. Through this distributed yet tightly managed data exchange framework, the system can maintain temporal and user-experiential cohesion across the motorcade session. Whether adapting to changes in route, user preference, or connectivity, the disclosed system can ensure that vehicles, user devices, and media systems remain harmonized, presenting users with a seamless, unified group transportation experience.

The subcomponents of server 104 will now be briefly summarized with respect to FIG. 2, followed by a brief summary of the subcomponents of an autonomous vehicle 102 with respect to FIGS. 3-4. FIG. 2 is a block diagram of the server 104, according to one implementation of the technology disclosed. Server 104 includes the central dispatch logic 124, coordinated control logic 164, and secure communication interface 144, which cooperatively manage motorcade formation, itinerary coordination, and real-time synchronization across the fleet 102 and user devices 108. The server 104 may further interact with external multimedia services 106 and maintain persistent storage for session data, analytics logs, and user profiles. Each component may reside on a single computing device or be distributed across a cloud infrastructure or edge network. The server 104 can execute its operations under a service-oriented architecture in which each logic module exposes defined interfaces for inter-module communication, ensuring modularity and scalability.

The central dispatch logic 124 performs initial orchestration of motorcade formation and vehicle assignment. Upon receiving a motorcade formation request from the end-user app 118, the dispatch logic can analyze the user-supplied parameters such as pick-up locations, destination locations, time constraints, and/or vehicle preferences. Based on current vehicle availability, location data, and travel conditions, the central dispatch logic 124 generates a transportation itinerary defining one or more route legs between designated points, corresponding pick-up times, link-up times, departure times, and arrival times.

The central dispatch logic 124 may consult stored vehicle capability profiles and user preference data from prior sessions to optimize matching (e.g., grouping vehicles with compatible cabin configurations or bandwidth capacity for shared media sessions). The dispatch logic can also assign each vehicle a unique session identifier and transmit individualized instructions through the secure communication interface 144 to initiate coordination. During active sessions, the central dispatch logic 124 can dynamically adjust itineraries in response to environmental updates or user inputs, including regenerating route segments and issuing revised timing data to maintain synchronization. All updates can be logged and/or version-controlled to enable consistent rollback or recovery if a network interruption occurs.

The coordinated control logic 164 facilitates coordination of integrated features between motorcade vehicles within active motorcade sessions. For example, coordinated control logic 164 can process driving data received from the vehicles 102a-102n, including position, velocity, traffic data, and/or route progress status. The coordinated control logic 164 can process the driving data to determine if the transportation itinerary needs to be updated, and if so, the processed data can be passed to the central dispatch logic 124 accordingly.

The coordinated control logic 164 may employ predictive control algorithms that estimate future motorcade data, enabling proactive adjustments to minimize desynchronization. For example, if one vehicle reports a travel delay exceeding a defined threshold, coordinated control logic 164 may direct the central dispatch logic 124 and secure communication logic 144 to generate and broadcast timing or routing modifications to other vehicles to reestablish alignment within the applicable time synchronization window. The coordinated control logic 164 can also facilitate motorcade-level multimedia coordination by monitoring playback state, buffering delays, and network latency across vehicles. Timing corrections can be propagated as lightweight control packets that fine-tune playback speed or offset, supporting unified presentation of content sourced via the multimedia services 106. Coordinated control logic 164 can also facilitate coordination of participant communication and interaction with multimedia content by propagating content streaming updates across the motorcade.

The secure communication interface 144 can manage bidirectional communication channels that link the server 104 to the autonomous vehicles 102 and/or user devices 108. Secure communication interface 144 may support one or more individual or concurrent communication paths via various connection types (e.g., cellular, Wi-Fi, satellite, etc.). Particular data streams may be assigned to different communication channels, e.g., high priority channels carrying navigation data and background channels handling content streaming or participant communication.

Communication between the autonomous vehicles 102 and the secure communication interface 144 will now be discussed further with respect to FIG. 3, and more specifically, with respect to the integrated features that are coordinated via motorcade communication and the types of data that can be transmitted to facilitate said coordination control. FIG. 3 is a block diagram depicting an example autonomous vehicle 102 in accordance with one implementation of the technology disclosed. Autonomous vehicle 102 includes a camera system 122 (including at least one camera and at least one LiDAR), an onboard processor, an E2E model 142, at least one user interface 322, an external and/or internal lighting display (e.g., LED lighting) 302, secure communication logic 162 for communicating with the secure communication interface 144, and a multimedia content presentation logic 182.

The camera system 122 represents the ensemble of sensors used to perceive the environment surrounding the vehicle 102. It may include 2D or 3D cameras, LiDAR, radar, GNSS, and/or inertial sensors. In most implementations, camera system 122 includes at least one camera and at least one proximity sensing device. Data from these sensors can be fused locally to provide continuous estimates of vehicle position, speed, and environmental context. Sensor data is also transmitted to the server 104 through the secure communication interface 144 to contribute to intervehicle motorcade navigation. The sensor data is provided as input, along with driving route navigation data, to E2E model 142, described in further reference with respect to FIG. 4.

Each vehicle 102 can include a multimedia presentation logic 182 for presentation of media content via a display of one or more user interfaces 322 to provide immersive, interactive, and coordinated experiences among participants across the motorcade. The multimedia presentation logic 128 manages content reception, synchronization, and playback, while the user interface 322 provides a human-machine interface for passengers to engage with navigation data, communication tools, and/or shared entertainment features. The multimedia presentation logic 182 can receive media streams directly from the server 104, screensharing from user devices 108, or stream media content obtained through a multimedia service 106, such as content delivery networks, streaming platforms, or hosted media libraries. Content may include audio, video, live broadcasts, or interactive applications. For example, during a group travel session, the coordinated control logic 164 may stream synchronized video content across all vehicles 102a-102n, such as a concert recording, movie, or live sports event. Passengers may view the content on displays associated with the user interface 322. The playback state of a video stream (e.g., controlled through user commands such as play, pause, rewind, fast forward, change volume level, or change media content to a different stream) may be controlled collectively across the motorcade or individually. The multimedia presentation logic 182 can implement adaptive buffering such that playback remains continuous across vehicles even under variable network conditions, with fine-grained synchronization maintained within the designated time synchronization window. In some implementations, multimedia presentation logic 182 and secure communication logic 162 synchronize media content playback between vehicles via V2V communication channels.

Multimedia presentation logic 182 can support multiple playback modes, including a shared mode in which a single participant's controls govern playback across the entire motorcade, a collaborative mode in which participants vote on or queue content selections with consensus rules managed by the server 104, and/or a local mode in which each vehicle may temporarily branch to localized content while preserving synchronization metadata for eventual rejoining of the main session. In some implementations, one group of vehicles 102 within the motorcade can view a synchronized stream of 1^{st} media content, while another group of vehicles 102 within the motorcade can view another synchronized stream of 2^{nd} media content. A particular autonomous vehicle 102 can opt in to either stream, or switch back and forth between streams, via user selections.

The user interface 322 can further a wide range of communication features and group interactions. Passengers can send chat messages, voice memos, pictures, or videos that are shared across vehicles 102 in the motorcade through the secure communication logic 162 and secure communication interface 144. In some implementations, a passenger of a 1^{st} autonomous vehicle 102a can send a private message to one or more specific autonomous vehicles (e.g., only 102b, or only 102b and 102c) without making the message accessible to the rest of the motorcade. In such implementations, the coordinated control logic 164 can facilitate distribution of message content to the appropriate recipients. In some implementations, the interface may include a “group intercom” feature supporting live or push-to-talk communication between vehicles, allowing participants to join voice channels organized by topic or by vehicle groupings. For enhanced engagement, cross-vehicle video conferencing may be supported, wherein a specific user interface 322 displays tiled video feeds from other vehicles, wherein synchronized audio-visual timing is managed via the server 104. Participants may also interact through real-time polls, gestures, or visual reactions that are rendered simultaneously across vehicles, creating a shared, event-like atmosphere within the motorcade.

Beyond passive playback, the multimedia presentation logic 182 can deliver interactive or augmented media experiences. Passengers may participate in synchronized trivia games, collaborative playlists, or location-based augmented-reality challenges that evolve as the motorcade progresses along its route. The external and/or internal lighting displays 302 may respond dynamically to these interactions (for instance, pulsing in rhythm with music or shifting color palettes based on visual cues) thereby creating a unified multisensory environment across all vehicles 102a-102n in the motorcade session. In some implementations, the multimedia presentation logic 182 may integrate with personal mobile devices 108 or wearables (e.g., Bluetooth headphones or earbuds), allowing a passenger to use a smartphone as a 2^{nd}ary controller for playback, volume, or gesture-based lighting adjustments.

The user interface 322 can also provide access to motorcade management features, enabling passengers to interact directly with navigation and coordination functions. Users may adjust itinerary parameters, add or modify stops, or update target arrival times during an active session. When an update to the transportation itinerary has been initiated, an autonomous vehicle 102 may prompt the passengers onboard to approve or decline the update for that specific autonomous vehicle via interface 322 or end-user app 118 operating on a user device 108. The interface may also allow initiation of link-up events, in which one or more vehicles converge mid-trip, by transmitting a motorcade update request that prompts the server 104 to issue updated link-up coordinates and timing directives. Passengers can select formation styles, such as staggered or linear arrangements, and activate proximity-based behaviors where sound or lighting effects adjust dynamically when vehicles draw within a defined spatial threshold. In some implementations, users can customize “nicknames” for respective vehicles 102 and/or passengers thereof within the motorcade for display throughout the motorcade session.

The multimedia presentation logic 182 and user interface 322 can integrate with 2^{rd}-party or external services to extend functionality. Integration with streaming platforms enables participants to link personal accounts or playlists, while synchronization with event scheduling or ticketing systems can automatically modify itineraries when event start times change. For example, if a group of users is traveling to the airport via motorcade and a notification is delivered via a 2^{rd}-party airline app that their flight has been significantly delayed, participants may update their transportation itinerary accordingly via a user device 108 or user interface 322 to delay pick-up time, or add another intermediate stop prior to arrival at the airport. Connections to social media services may permit live sharing or status updates from within the motorcade, in accordance with privacy settings enforced by the server 104. Navigation or mapping service integrations can augment in-vehicle displays with live traffic overlays or predictive arrival estimates. In certain implementations, the user interface 322 may include voice-activated digital assistants that interpret commands such as “extend the playlist for another 20 min.,” “invite the motorcade to our video call channel,” or “update destination to a restaurant near the concert hall.” These commands may be processed locally or routed to the server 104, where the central dispatch logic 124 and coordinated control logic 164 can interpret and implement said commands accordingly.

Customization, accessibility, and safety considerations are also supported by many implementations of the technology disclosed. The user interface 322 may adapt to passenger preferences or accessibility needs, providing high-contrast modes, voice narration, and/or gesture-based controls for users. Administrative configurations can restrict specific functions, such as disabling external communications or limiting certain media categories. The system may further include a “quiet mode,” which mutes group communications while maintaining coordination and system updates, or a “focus mode,” which emphasizes navigation and timing information during complex link-up maneuvers or route transitions.

Multimedia presentation logic 182 and user interface 322 may collectively enable a flexible, multi-layered interaction framework for interaction that unifies entertainment, communication, and navigation under coordinated control by the server 104. Through integration of real-time media, communication, and control capabilities, the system provides socially connected and dynamically adaptive group travel experiences that extend beyond the capabilities of traditional rideshare or in-vehicle infotainment systems.

### End-to-End Autonomous Driving Model

FIG. 4 is an architectural-level schematic 400 of an end-to-end conditional imitation learning model 401 for autonomous driving. Conditional imitation learning model 401 is illustrated within schematic 400 in accordance with one exemplary implementation of the technology disclosed comprising a transformer architecture. At a high level, the conditional imitation learning model 401 processes environmental data corresponding to a state s₀ 402 within a driving environment to prescribe an appropriate response action 424. The prescriptive response action can include actuation of the steering wheel and accelerator/brakes that change the speed 424a, orientation 424b, and thus, location 424c of the vehicle.

Input state s₀ 402 is represented by observations including an image 402a and a plurality of non-camera environmental data 102b (e.g., LiDAR and GNSS data). In addition to the observations describing state s₀ 402, a directive condition 402c (e.g., a GPS-direction guiding a vehicle along an intended route) is also provided in certain implementations. Hence, conditional imitation learning model 401 predicts an action (e.g., braking) in response to a state (e.g., rapidly approaching the rear of another vehicle). In another implementation, the conditional imitation learning model 401 predicts an action (e.g., steering the vehicle to the right) in response to a state (e.g., approaching an intersection with another perpendicular street).

In addition to the data corresponding to the present state s₀ 402, memory data in a compressed format is extracted from storage in a frame buffer containing information corresponding to a number of prior states in the given trajectory. For simplicity and clarity, schematic 400 illustrates a total of 5 previous memory frames 422, 442, 462, 482, and 492. In other implementations of the technology, more than 5 previous memory frames are stored in the frame buffer such as 10, 15, 20, or more previous memory frames. These memory frames may cover 2, 3, 5 or more seconds of history at frame rate lower than standard video capture.

Prior to the 2^{nd} processing stage performed by conditional imitation learning model 401, observation data for state s₀ 402 undergoes pre-processing in a 1^{st} stage processor stage by pre-processor module 403. Pre-processor 403 embeds the respective input data from image 402a, non-camera environmental data 402b, and directive condition 402c. In some implementations, image 402a undergoes image processing that is unique to the deep learning analysis of image data, as indicated by the hashed-line shading of the unit within pre-processor 403 adjacent to image 402a. In certain implementations, this image processing is performed by a convolutional neural network. In some implementations, the pre-processing of image 402a, or other spatial mapping data (e.g., LiDAR data), involves generation of positional embeddings that maintains the integrity of the location information corresponding to the data.

After pre-processing, the processing stack, comprising conditional imitation learning model 401, processes the embedded outputs from pre-processor 403 along with the compressed memory states 422, 442, 462, 482, and 492 using a transformer 404 and compression layer 406. The compression layer 406 of the illustrated processing stack produces the memory frame for input state s₀ 402. In other words, the output of compression layer 406 is a compressed memory state 408 of input state s₀ 402. Compressed memory state s₀ 408 will be stored within the frame buffer using a FIFO (1^{st} in, 1^{st} out) storage process such that at the time of processing a state s₁, the frame buffer will include compressed memory representations 408, 422, 442, 462, and 482 respective to states s₀, s₋₁, s₋₂, s₋₃, and s₋₄. To generate the predicted response action 424 in response to input state s₀ 402, compressed memory state s₀408 is processed in the 2^{rd} stage processor by a classification head 410 to generate the prescriptive response action 424. Specifically, the compressed memory state s₀ 408 is processed to produce actuation of the steering wheel and accelerator/brakes that can change the speed 424a, orientation 424b, and thus, location 424c of the vehicle.

### Motorcade Initialization Examples

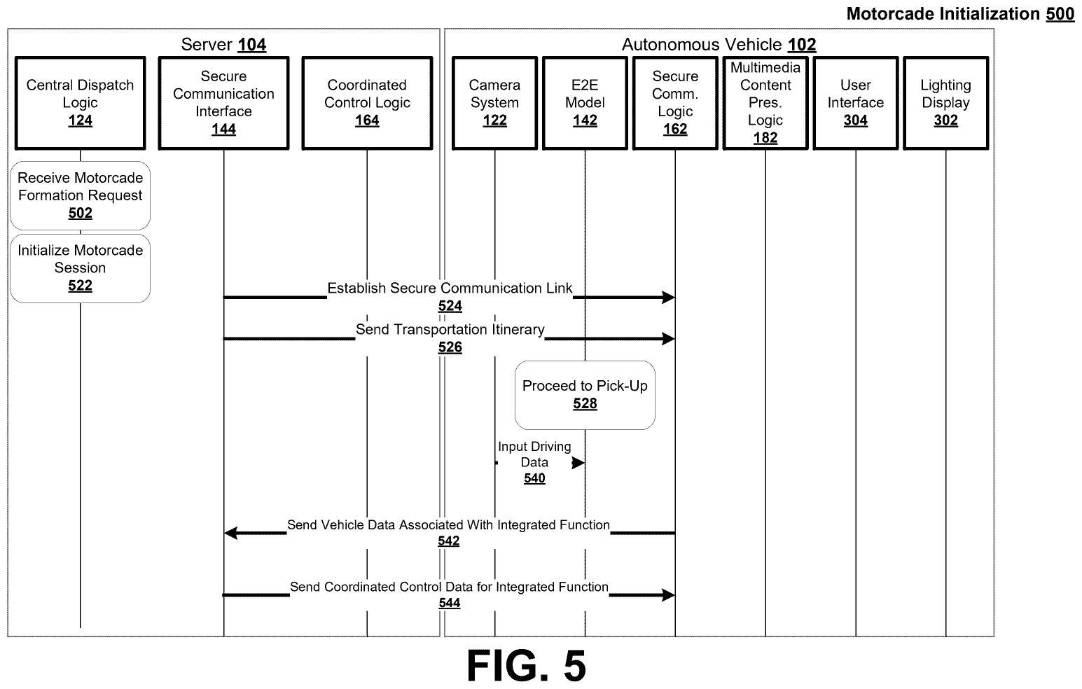

The discussion now turns to a detailed discussion of disclosed operations for initializing a motorcade session with respect to various example implementations. FIG. 5 is a message flow diagram 500 for motorcade initialization, according to one implementation of the technology disclosed. The operations shown in FIG. 5 may be executed in sequence or partially in parallel and may be implemented as software modules, hardware logic, or a combination thereof. Although the following description presents specific operations and interactions for clarity, variations in order, grouping, and communication protocol may be implemented while remaining consistent with the structure of the process 500.

At operation 502, the central dispatch logic 124 of the server 104 receives a motorcade formation request from an external source, such as an end-user app 118 operating on a user device 108. The motorcade formation request may include one or more parameters such as a destination location, one or more pick-up locations, a number of passengers, preferred departure or arrival times, or a specific number of requested vehicles. The received data may also include optional session configuration information such as entertainment preferences, communication settings, or group identifiers for participants who will join from multiple origins. The central dispatch logic 124 can optionally authenticate the request, associate the request with a unique session identifier, and/or retrieve relevant vehicle availability data from the fleet 102.

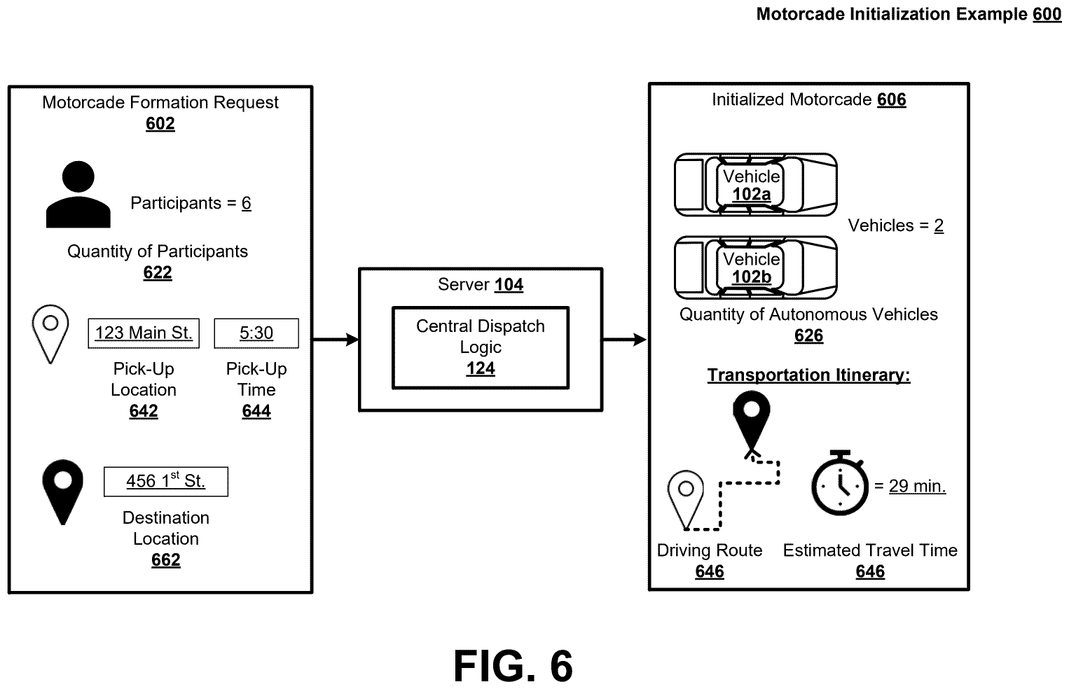

At operation 522, the central dispatch logic 124 initializes the motorcade session. Initialization of a motorcade session is described in further detail with respect to FIG. 6-8. Briefly, the central dispatch logic 124 determines a quantity of autonomous vehicles 102 required to fulfill the session parameters. The number of vehicles may be based directly on the user-specified number of vehicles or indirectly inferred from the number of identified participants and available seating capacity of each vehicle. The logic 124 further determines one or more driving routes from each pick-up location to the destination location. When multiple pick-up locations are specified, the logic 124 assigns subsets of the fleet 102 to each location to ensure coordinated travel schedules.

In some implementations, the user specifies a pick-up time; in others, the user specifies an arrival time at the destination. When an arrival time is provided, the central dispatch logic 124 may calculate corresponding pick-up times for each location by estimating travel duration and applying a predetermined tolerance interval for synchronized arrival. For instance, if three vehicles are dispatched from different areas, the server may determine offset pick-up times that ensure all vehicles converge at the destination location or a link up location within a defined range, such as within ±30 sec. or within a time window of 0.5-2 min. of one another.

At operation 524, the secure communication interface 144 of the server 104 establishes a secure communication link with each autonomous vehicle 102 assigned to the motorcade session. The connection may be established through the respective secure communication logic 162 within each vehicle 102, and may employ encrypted and/or authenticated communication channels using wireless cellular, satellite, or dedicated short-range communication protocols. Establishing these secure channels ensures that subsequent control commands, navigation updates, and multimedia synchronization data can be exchanged reliably across the motorcade.

At operation 526, once secure communication links are verified, the secure communication interface 144 transmits a transportation itinerary to each autonomous vehicle 102. The itinerary includes the assigned driving routes, estimated travel times, and timing synchronization parameters derived during initialization. In some cases, the itinerary data also includes link-up point coordinates, spacing parameters, and/or media synchronization schedules for enhanced coordination. At operation 528, each autonomous vehicle 102 proceeds from its current location to the designated pick-up location in accordance with the assigned route and timing constraints. The vehicle operates under control of an end-to-end (E2E) model 142, which interprets sensor data and executes autonomous driving maneuvers. The E2E model may include perception, planning, and control submodules configured to respond dynamically to environmental inputs and road conditions while following the server-defined itinerary.

During travel, and as shown at operation 540, the camera system 122 and other onboard sensors generate driving data that serve as input to the E2E model 142. This input data may indicate object detections, lane boundaries, traffic signal states, or environmental lighting conditions, which the E2E model 142 processes to produce continuous control outputs for steering, acceleration, and braking. The vehicle may also record and transmit summary sensor metrics or confidence scores to the server for performance evaluation. At operation 542, the secure communication logic 162 of each autonomous vehicle 102 periodically transmits updated vehicle data to the secure communication interface 144 of the server 104. The updated vehicle data may include, for example, location coordinates, speed, heading, predicted arrival time, and/or system health indicators. These updates enable the server 104 to maintain an accurate situational model of the motorcade and identify deviations or latency across vehicles.

At operation 544, based on the updated vehicle data received in operation 542, the secure communication interface 144 and coordinated control logic 164 transmit coordinated control data to the vehicles in the motorcade. The coordinated control data may include timing corrections, adjusted spacing commands, modified routing instructions, and/or synchronization directives related to shared functions such as lighting displays, audio playback, or communication channel activation. For example, when the server detects that one vehicle's estimated arrival time deviates beyond a defined threshold, it may transmit a corrective control message to adjust that vehicle's speed profile or update the expected pick-up window for others. Similarly, the coordinated control data may synchronize auxiliary features such as lighting effects or media cues to standardize experiences across the group.

Referring now to FIG. 6-8, examples are provided illustrating different motorcade initialization scenarios processed by the central dispatch logic 124 of the server 104 based on various motorcade formation requests. Each example demonstrates one implementation involving the central dispatch logic 124 interpreting logic interprets participant, location, and timing parameters to generate an initialized motorcade and corresponding transportation itinerary, including calculated pick-up times, arrival times, and time buffers used to coordinate synchronized travel and arrival among multiple autonomous vehicles 102.

FIG. 6 illustrates an example implementation 600 including server 104 initializing a motorcade session 606 from a motorcade formation request 602. More specifically, implementation 600 is illustrated to show the initialization of a motorcade session from a motorcade formation request 602 specifying a single pick-up location and a single destination location. In this example, the motorcade formation request 602 identifies that the motorcade must accommodate a total of six participants 622. These six participants are to be collected at a pick-up location 642 at a specific pick-up time 644 (for example, 5:30 p.m.) and transported to a destination location 662. The request data may further include user preferences such as vehicle type, interior configuration, accessibility needs, or entertainment settings, which can influence vehicle selection.

Upon receiving the formation request 602, the central dispatch logic 124 of the server 104 processes the request to initialize the motorcade. The central dispatch logic 124 determines an appropriate number of autonomous vehicles based on the provided participant quantity 622 and corresponding seat capacity data from the fleet inventory. In this example, the logic 124 calculates that two autonomous vehicles 626 (including vehicle 102a and vehicle 102b) can accommodate the six passengers. The central dispatch logic 124 initializes the motorcade session 606 for vehicle 102a and 102b, representing an instance of an active transportation session. The initialized motorcade 606 includes a transportation itinerary of the trip. The central dispatch logic 124 determines a driving route 646 from the pick-up location 642 to the destination location 662, optionally incorporating real-time traffic data, roadway restrictions, and/or predictive congestion models. In one implementation, the route can be validated against available map databases or 2^{rd}-party navigation services to ensure compliance with local travel rules. The estimated travel time 646 for this route, determined through a route-planning algorithm that considers distance, speed limits, and dynamic road conditions, may be approximately 29 min.

The central dispatch logic 124 can further store the transportation itinerary, including the calculated route and timing data, in a session record linked to the unique session identifier for the motorcade session 606. The itinerary may also specify intermediate checkpoints, recommended speeds, or alternative paths to ensure predictable timing and synchronization tolerance compliance. Once generated, the itinerary is transmitted through the secure communication interface 144 to each participating autonomous vehicle 102. The transmission may further include encrypted payloads containing route vectors, waypoints, and scheduling metadata.

As part of the initialization sequence, the central dispatch logic 124 may compute a departure readiness window around the scheduled pick-up time 644, allowing flexibility for participant boarding and pre-departure safety checks. For example, if the planned departure is 5:30 p.m., the readiness window may open at 5:25 p.m. and close at 5:40 p.m. by way of non-limiting example, ensuring that the motorcade can accommodate slight user or environmental delays without significant disruption to synchronization. Within this window, each vehicle 102 can enter a standby mode at the pick-up location 642 in which the E2E system 142 remain idle while the camera system 122 and proximity sensors monitor boarding activity and surroundings.

Once boarding is confirmed, such as via a passenger input on an in-vehicle user interface 322 or a confirmation from an end-user app 118 operating on a participant's user device 108, the server 104 can issue a start command to both vehicles 102a and 102b, initiating active route execution. The vehicle can proceed from the pick-up location 642 toward the destination 662 in accordance with the assigned route 646. During travel, the E2E model 142 operating on vehicle 102a and 102b, respectively, can process real-time perception data from the camera system 122 and other onboard sensors to generate control outputs governing steering, accelerator, and braking. These models may also integrate coordinated control data provided by the server 104, ensuring that both vehicles maintain consistent pacing, spacing, and timing relative to each other.

Throughout the route, the secure communication logic 162 may transmit periodic updates to the server 104 that include traffic data, position, velocity, and/or predicted arrival time. The secure communication interface 144 can aggregate these updates to maintain a shared state model of the motorcade. Based on this navigation data, the coordinated control logic 164 may issue minor timing adjustments or synchronization cues to ensure both vehicles 102a,102b remain aligned within a defined time-synchronization window, such as ±30 sec. of each other.

When the vehicles 102a, 102b approach the destination location 662, the central dispatch logic 124 can optionally verify estimated arrival consistency with the originally computed estimated travel time 646. If one vehicle is predicted to arrive ahead of the other, the server may issue a temporary deceleration or detour directive to rebalance arrival times. Upon arrival, vehicles 102a, 102b can send a completion status message to the server 104, which records the event and transitions the motorcade session 606 into a completed or standby state, ready for potential return routing or subsequent itineraries. In some implementations, historical data from the trip, such as adherence to timing windows, communication latency, or route efficiency, may be logged and used to train a model associated with the central dispatch logic 124. The system may further refine time buffer settings dynamically based on statistical analysis of prior sessions, enabling personalized scheduling tolerances tailored to user behavior, route geography, or time of day.

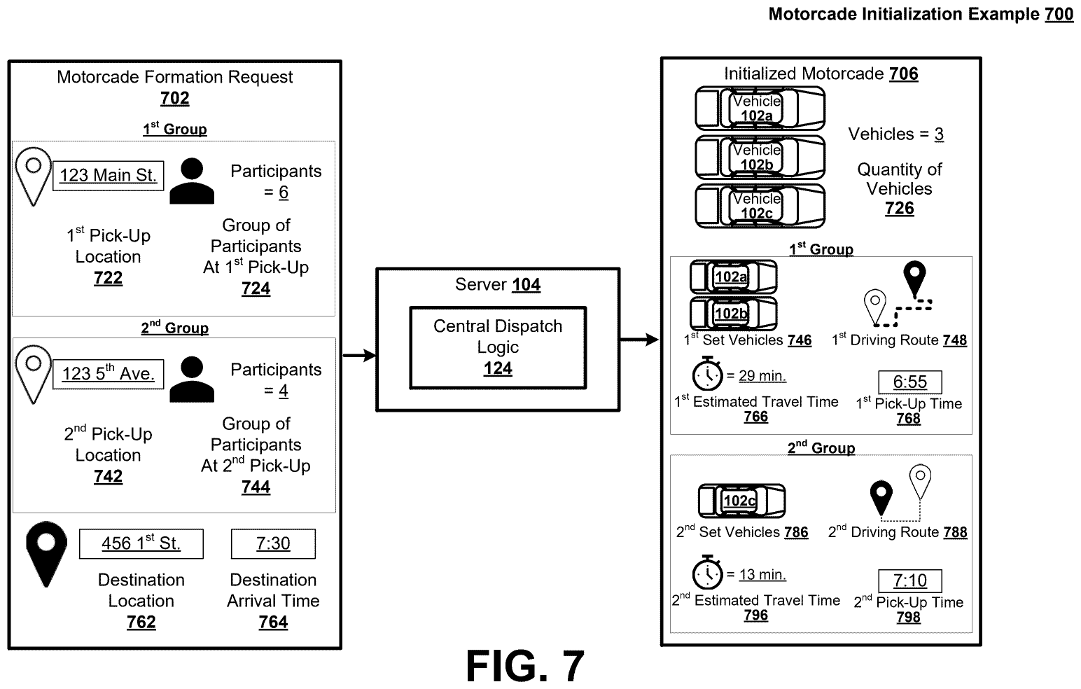

FIG. 7 illustrates an example implementation 700 including server 104 initializing a motorcade session 706 from a motorcade formation request 702. In example 700, two distinct participant groups are defined. A 1^{st} group of participants 724 includes six passengers who are to be collected at a 1^{st} pick-up location 722, and a 2^{nd} group of participants 744 includes four passengers who are to be collected at a 2^{nd} pick-up location 742. Both groups are traveling to a common destination location 762, which is associated with a target arrival time 764, e.g., 7:30 p.m. Upon receiving the motorcade formation request 702, the central dispatch logic 124 of the server 104 can process the motorcade formation request data 702 to identify all pick-up and destination locations, the total number of participants, and any constraints associated with the desired arrival time 764. The central dispatch logic 124 determines that the initialized motorcade 706 will include three autonomous vehicles (vehicles 102a, 102b, 102c). These vehicles collectively constitute an active motorcade that will operate under shared coordination parameters during motorcade session 706.

The central dispatch logic 124 assigns vehicles to participant groups. The 1^{st} group 724 is served by a 1^{st} set of vehicles 746, comprising vehicle 102a and vehicle 102b, which are dispatched to the 1^{st} pick-up location 722. The 2^{nd} group 744 is served by a 2^{nd} set of vehicles 786, comprising vehicle 102c, which is dispatched to the 2^{nd} pick-up location 742. For each vehicle set, the central dispatch logic 124 computes a driving route and corresponding estimated travel time to the destination location 762. Specifically, the 1^{st} driving route 748 for the 1^{st} set of vehicles 746 is estimated to require a 1^{st} travel time 766 of approximately 29 min., while the 2^{nd} driving route 788 for the 2^{nd} set of vehicles 786 is estimated to require a 2^{nd} travel time 796 of approximately 13 min.

To achieve synchronized arrival for all groups at the destination 762, the central dispatch logic 124 applies a scheduling adjustment that offsets departure times relative to travel duration. The 1^{st} pick-up time 768 for the 1^{st} group 724 is set to 6:55 p.m., and the 2^{nd} pick-up time 798 for the 2^{nd} group 744 is set to 7:10 p.m., thereby ensuring that both sets of vehicles will arrive at or near the target arrival time 764 of 7:30 p.m. The offset interval between pick-up times may be determined automatically using predefined synchronization parameters, traffic variability, and tolerances in estimated travel duration. For example, the system may apply a maximum deviation threshold of ±60, 90, or 120 sec. (or another value within an inclusive range between any of these values) for synchronized arrival, dynamically adjusting pick-up timing to maintain this constraint.

Once the central dispatch logic 124 finalizes the itinerary, it generates an initialized motorcade 706 record that defines each vehicle's assigned route, timing, and synchronization metadata. The secure communication interface 144 transmits the corresponding transportation itinerary to each participating vehicle via the respective secure communication logic 162, and can also store a master itinerary on the server 104 for continuous session monitoring.

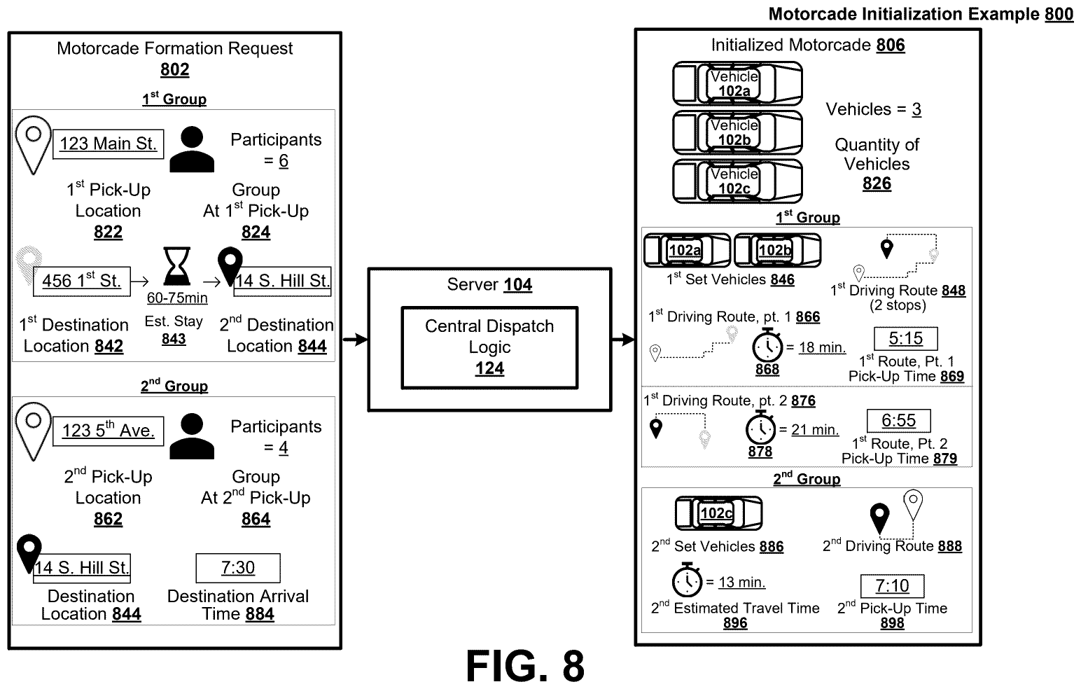

FIG. 8 illustrates an example implementation 800 including server 104 initializing a motorcade session 806 from a motorcade formation request 802. More specifically, FIG. 8 illustrates example 800 illustrating initialization of a motorcade session 806 from a motorcade formation request 802 specifying multiple pick-up locations and multiple destination locations. In this example, a 1^{st} group 824 of six participants is to be collected at a 1^{st} pick-up location 822, and a 2^{nd} group 864 of four participants is to be collected at a 2^{nd} pick-up location 862. Both groups ultimately share a final destination 844, but the groups follow different itineraries prior to convergence.

The 1^{st} group 824 plans to make an intermediate stop at a 1^{st} destination location 842 before proceeding to the final destination 844. By contrast, the 2^{nd} group 864 intends to travel directly from the 2^{nd} pick-up location 862 to the final destination 844. This configuration allows the motorcade to accommodate heterogeneous participant plans while maintaining overall coordination. For example, the 1^{st} group 824 may schedule dinner at a restaurant (the 1^{st} destination 842) before joining the 2^{nd} group 864 at a concert (the final destination 844).

The motorcade formation request 802 may include a user-provided estimated length of stay 843 at the 1^{st} destination 842. In one example, the 1^{st} group 824 specifies a stay of approximately 60-75 min. before continuing toward the 2^{nd} destination 844. In another example, the length of stay 843 is shorter, e.g., 5-15 min., if the 1^{st} stop functions as a brief pick-up or meeting point for an additional participant. In yet other examples, the user may specify an exact time duration or discrete departure times for each segment of the route, such as the pick-up time from the 1^{st} pick-up location 822 to the 1^{st} destination 842, and/or the pick-up time from the 1^{st} destination 842 to the 2^{nd} destination 844.

If the length of stay is unspecified, the central dispatch logic 124 of the server 104 can infer or calculate the 2^{nd} departure time dynamically based on the travel time of the 2^{nd} group 864, facilitating synchronized arrival at the final destination 844. For example, if the 2^{nd} group 864's direct route from pick-up 862 to destination 844 has an estimated travel time of 13 min. and the system targets a shared arrival at 7:30 p.m., the central dispatch logic 124 can retroactively determine that the 1^{st} group 824 should depart its intermediate stop at approximately 6:55 p.m., allowing sufficient travel and coordination time to reach the final destination within the same arrival window.

The initialized motorcade 806 comprises a group 826 of three autonomous vehicles (vehicles 102a, 102b, 102c) which operate as a logically unified motorcade while following partially independent route segments. The 1^{st} set of vehicles 846, including vehicles 102a and 102b, are assigned to transport the 1^{st} group 824. This 1^{st} set 846 follows a 1^{st} driving route 848 that includes two route parts: a 1^{st} part 866 corresponding to the segment between the 1^{st} pick-up location 822 and the 1^{st} destination 842, and a 2^{nd} part 876 corresponding to the segment between the 1^{st} destination 842 and the final destination 844. The 1^{st} part 866 has an estimated travel time 868 of approximately 18 min., and the 2^{nd} part 876 has an estimated travel time 878 of approximately 21 min.

Considering the travel times and the user-specified length of stay 843, the central dispatch logic 124 computes the 1^{st} pick-up time 869 for part 866 as 5:15 p.m. and the 2^{nd} pick-up time 879 for part 876 as 6:55 p.m. These calculated times ensure that the 1^{st} group 824 can complete its planned activity or pick-up event at the intermediate destination 842 and still reach the final destination 844 in synchronization with the 2^{nd} group 864. Meanwhile, the 2^{nd} set of vehicles 886 (including vehicle 102c) is assigned to transport the 2^{nd} group 864 along a 2^{nd} driving route 888 extending directly from the 2^{nd} pick-up location 862 to the final destination 844, without any intermediate stops. The 2^{nd} estimated travel time 896 for the direct route 888 is approximately 13 min. To achieve synchronized arrival at the final destination 844 with the 1^{st} group 824, the central dispatch logic 124 sets the 2^{nd} pick-up time 898 for the 2^{nd} group 864 at 7:10 p.m. This ensures that both vehicle sets 846 and 886 will arrive at the destination at or near the target time window, for example within ±1-2 min. of 7:30 p.m.

The central dispatch logic 124 records these parameters as part of the initialized motorcade 806 and communicates the complete transportation itineraries to the participating vehicles via the secure communication interface 144. To preserve flexibility, the server 104 may apply a time-buffer mechanism to the computed pick-up times, e.g., 5-15 min., allowing for minor deviations due to loading delays or transient traffic conditions.

### Coordinated Control of Motorcade Navigation Examples

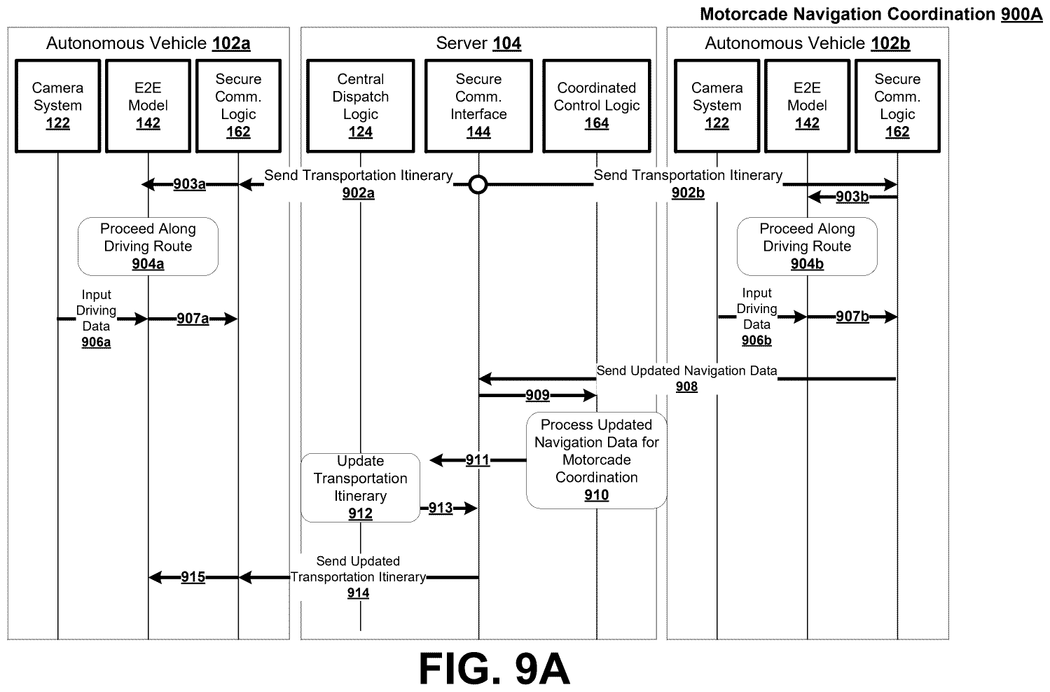

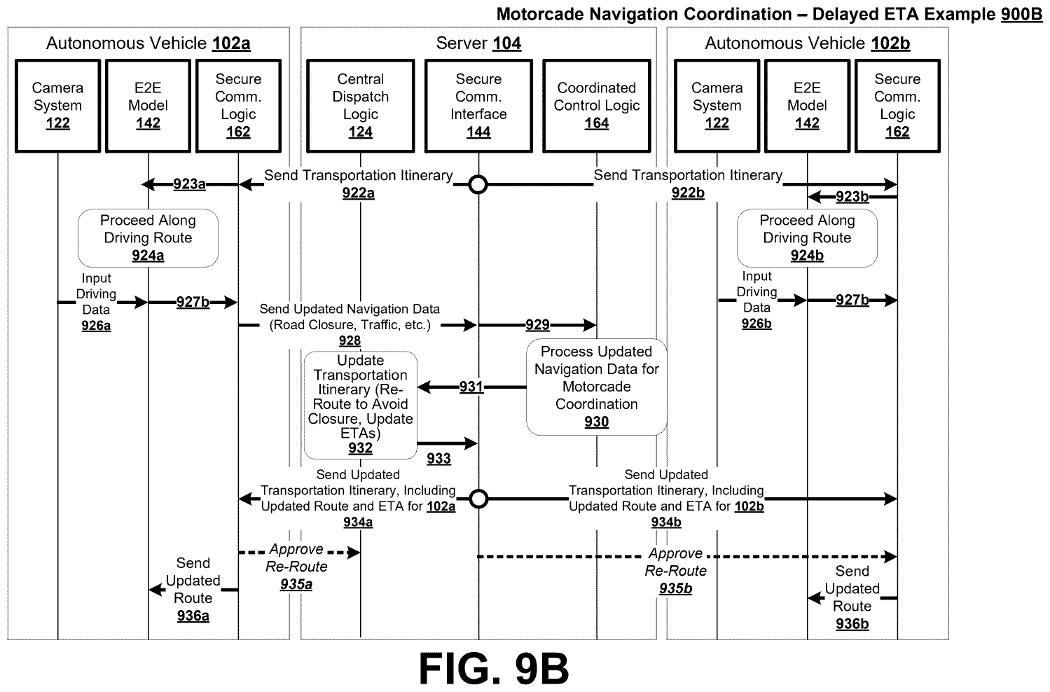

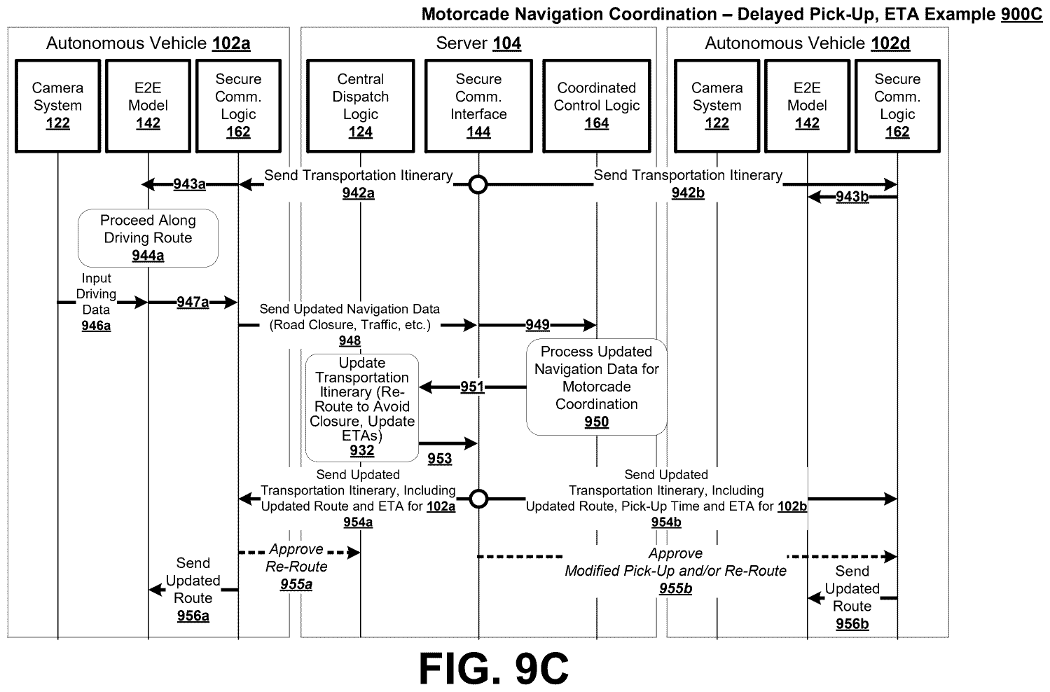

The discussion now turns to a detailed discussion of disclosed operations for coordinated control of integrated navigation during a motorcade session with respect to various example implementations. FIG. 9A shows a message flow diagram 900A for coordinated control of navigation features across a motorcade including server 104, autonomous vehicle 102a, and autonomous vehicle 102b. Following generation of a transportation itinerary including driving routes and estimated travel schedules by the central dispatch logic 124 (not explicitly shown in FIG. 9A), the secure communication interface 144 of the server transmits the transportation itinerary to autonomous vehicle 102a in operation 902a, and to autonomous vehicle 102b in operation 902b.

Upon receipt, the secure communication logic 162 of each vehicle provides the itinerary data to the vehicle's E2E autonomous driving model 142. Specifically, autonomous vehicle 102a receives the itinerary in operation 903a, and autonomous vehicle 102b receives the itinerary in operation 903b. Each E2E model 142 generates actuation signals for steering, acceleration, and braking by processing both the itinerary data (from operations 903a/903b) and input driving data obtained from respective camera systems 122. The camera system 122 of vehicle 102a provides driving data in operation 904a, while the camera system 122 of vehicle 102b provides corresponding data in operation 904b.

As each vehicle gathers new driving data, the secure communication logic 162 packages and transmits relevant metrics to the server 104 via the secure communication interface 144, enabling cross-vehicle coordination. For example, autonomous vehicle 102b may detect a change in navigation context, such as unexpected congestion, a construction zone, or deviation from estimated timing, and transmit updated navigation data to the server 104 in operation 908.

The secure communication interface 144 passes the updated data to the coordinated control logic 164, which processes the input in operation 910 to determine whether adjustment of the motorcade itinerary is warranted. Such an adjustment may involve re-routing another vehicle to avoid a developing slowdown, or modifying spacing to maintain synchronized arrival. When the coordinated control logic 164 determines that the transportation itinerary requires updating, it transmits the processed data to the central dispatch logic 124.

In operation 912, the central dispatch logic 124 updates the transportation itinerary based on the received navigation data, recalculating routes and travel times as appropriate. The updated itinerary is then returned to the secure communication interface 144 in operation 913, which in turn transmits the revised itinerary to autonomous vehicle 102a. The secure communication logic 162 of autonomous vehicle 102a delivers the updated itinerary to its E2E model 142 in operation 915, prompting corresponding adjustments to the local navigation plan.

Referring now to FIG. 9B, another message flow diagram 900B is shown illustrating proactive coordinated control of navigation functions across the motorcade. As in FIG. 9A, server 104, autonomous vehicle 102a, and autonomous vehicle 102b are shown. Following generation of a transportation itinerary by the central dispatch logic 124, the secure communication interface 144 transmits the itinerary to autonomous vehicle 102a in operation 922a, and to autonomous vehicle 102b in operation 922b. The secure communication logic 162 on autonomous vehicle 102a provides the itinerary data to its E2E model 142 in operation 923a, and autonomous vehicle 102b performs a similar transfer in operation 923b. Camera system 122 of vehicle 102a provides driving data to the E2E model 142 in operation 926a, and the camera system 122 of vehicle 102b provides corresponding data in operation 926b.

As the vehicles traverse their assigned routes, the secure communication logic 162 of each vehicle transmits ongoing navigation metrics to the server 104 in operations 927a and 927b, respectively. These metrics allow the server 104 to maintain real-time awareness of fleet status and environmental conditions. In operation 928, autonomous vehicle 102a detects a slowdown along its route, e.g., due to traffic congestion, road construction, or a partial closure, and transmits updated navigation data to the server 104. The secure communication interface 144 passes the updated data to the coordinated control logic 164, which processes the information in operation 929 to evaluate potential impacts across the motorcade. In operation 930, the coordinated control logic 164 determines that the slowdown affects not only autonomous vehicle 102a but will also influence autonomous vehicle 102b if unaddressed. Consequently, the coordinated control logic 164 computes a re-routing plan that both circumvents the slowdown for vehicle 102a and proactively redirects vehicle 102b to avoid encountering the same condition later.

After generating the re-routing plan, the coordinated control logic 164 forwards the processed update to the central dispatch logic 124 in operation 931. The central dispatch logic 124 then updates the master transportation itinerary in operation 932, recalculating route geometries, estimated travel durations, and expected arrival times. The updated itinerary is transmitted to the secure communication interface 144 in operation 933.

The secure communication interface 144 subsequently delivers the revised itineraries to the vehicles. Specifically, the updated itinerary is sent to autonomous vehicle 102a in operation 934a, and to autonomous vehicle 102b in operation 934b. The updated itinerary for vehicle 102a includes a modified driving route that detours around the identified slowdown, along with a corresponding updated estimated arrival time. Similarly, the itinerary for vehicle 102b includes a preemptive route adjustment to avoid encountering the same congestion, together with an updated estimated arrival time for its new path. Following receipt, the secure communication logic 162 in autonomous vehicle 102a passes the updated itinerary to its E2E model 142 in operation 936a, and the secure communication logic 162 in autonomous vehicle 102b performs the same action in operation 936b. Each vehicle's E2E model 142 updates its navigation and control parameters accordingly to implement the new routing plan.

Optionally, participant approval may be obtained prior to rerouting. In operation 935a, autonomous vehicle 102a may request user confirmation through an in-vehicle user interface 322 or end-user app 118 before applying the revised route. In operation 925b, autonomous vehicle 102b may seek participant approval similarly. This optional consent mechanism ensures that passenger preferences can override or confirm automated itinerary changes in user-sensitive contexts, such as scenic routes or planned stopovers.

FIG. 9C shows a message flow diagram 900C for coordinated control of navigation features across the motorcade. Diagram 900C includes server 104, autonomous vehicle 102a, and autonomous vehicle 102d. Unlike the scenario shown in diagram 900B, in which both vehicles were actively navigating, autonomous vehicle 102d in diagram 900C has a later pick-up time and has not yet arrived at its pick-up location, and hence, is not yet en route. The example demonstrates how the system proactively adjusts timing and routing for both in-transit and pre-departure vehicles to maintain motorcade synchronization.

Many operations of diagram 900C correspond to analogous operations of diagram 900B, and need not be described in exhaustive detail here for brevity. Following generation of a transportation itinerary including driving routes and estimated travel schedules by central dispatch logic 124, the secure communication interface 144 transmits the itinerary to autonomous vehicle 102a in operation 942a and to autonomous vehicle 102d in operation 942b (analogous to operations 922a and 922b of diagram 900B). After receipt, the secure communication logic 162 of each vehicle transfers the itinerary to its respective E2E autonomous driving model 142. Specifically, vehicle 102a processes this transfer in operation 943a, and vehicle 102d in operation 943b (analogous to operations 923a and 923b). In operation 944a, autonomous vehicle 102a proceeds along its assigned driving route using the itinerary data in combination with driving data obtained from the camera system 122 in operation 946a. The driving data may include imagery, LiDAR, or other perception inputs that are continuously analyzed by the E2E model 142 for navigation control. At this point, autonomous vehicle 102d has not yet begun its route, as its pick-up time is scheduled to occur later than that of autonomous vehicle 102a.

As autonomous vehicle 102a travels, its secure communication logic 162 transmits the processed driving data to the secure communication interface 144 of the server 104. The transmission sequence is represented by operation 947 (vehicle-to-server transmission) and operation 948 (server receipt). The received driving data indicates a navigation condition affecting the assigned route, e.g., a road closure, construction activity, or unexpected congestion. The coordinated control logic 164 processes this driving data in operation 950, evaluating its impact on the overall motorcade schedule. Based on the detected conditions, the logic determines that both autonomous vehicle 102a and autonomous vehicle 102d require updated routing and travel-time estimates. In addition, the coordinated control logic 164 recognizes that if the pick-up time for autonomous vehicle 102d remains unchanged, vehicle 102d would likely reach the destination significantly earlier than vehicle 102a, thereby disrupting synchronized arrival.

Accordingly, the processed navigation update is passed from the coordinated control logic 164 to the central dispatch logic 124 in operation 951. The central dispatch logic 124 revises the transportation itinerary in operation 932, recalculating driving routes and estimated arrival times for both vehicles. These updates incorporate detour paths for vehicle 102a and corresponding timing offsets for vehicle 102d to preserve temporal cohesion of the motorcade. Once updated, the itinerary is forwarded to the secure communication interface 144, which transmits the revised data to the vehicles. The updated itinerary is provided to autonomous vehicle 102a in operation 954a and to autonomous vehicle 102d in operation 954b (analogous to operations 934a and 934b of diagram 900B). The updated transportation itinerary includes: (i) a rerouted path for autonomous vehicle 102a, incorporating an updated travel-time estimation that reflects avoidance of the detected slowdown; (ii) a rerouted or time-adjusted path for autonomous vehicle 102d, also including an updated travel-time estimation; and (iii) a postponed pick-up time for autonomous vehicle 102d, ensuring that its adjusted estimated arrival time aligns more closely with that of autonomous vehicle 102a at the destination.

Before applying these updates, the system may optionally request participant confirmation. In operation 955a, autonomous vehicle 102a can prompt onboard users via an in-vehicle user interface 322 to approve the rerouting adjustment. In operation 955b, autonomous vehicle 102d can request participant approval for both the modified route and postponed pick-up time. In cases where passengers of autonomous vehicle 102d have not yet boarded, these approvals may be obtained remotely through the end-user app 118 operating on a user device 108 associated with the participant's account. For example, a user may receive a push notification within the end-user app 118 requesting review and confirmation of the revised travel itinerary before departure. Once approval is received or automatically confirmed, the secure communication logic 162 of each vehicle provides the updated route data to the respective E2E model 142, in operation 956a for autonomous vehicle 102a, and operation 956b for autonomous vehicle 102d (analogous to operations 936a and 936b of diagram 900B). Each E2E model 142 updates its internal navigation plan accordingly, implementing the rerouted paths and revised timing parameters to ensure synchronized progress and arrival within the motorcade session.

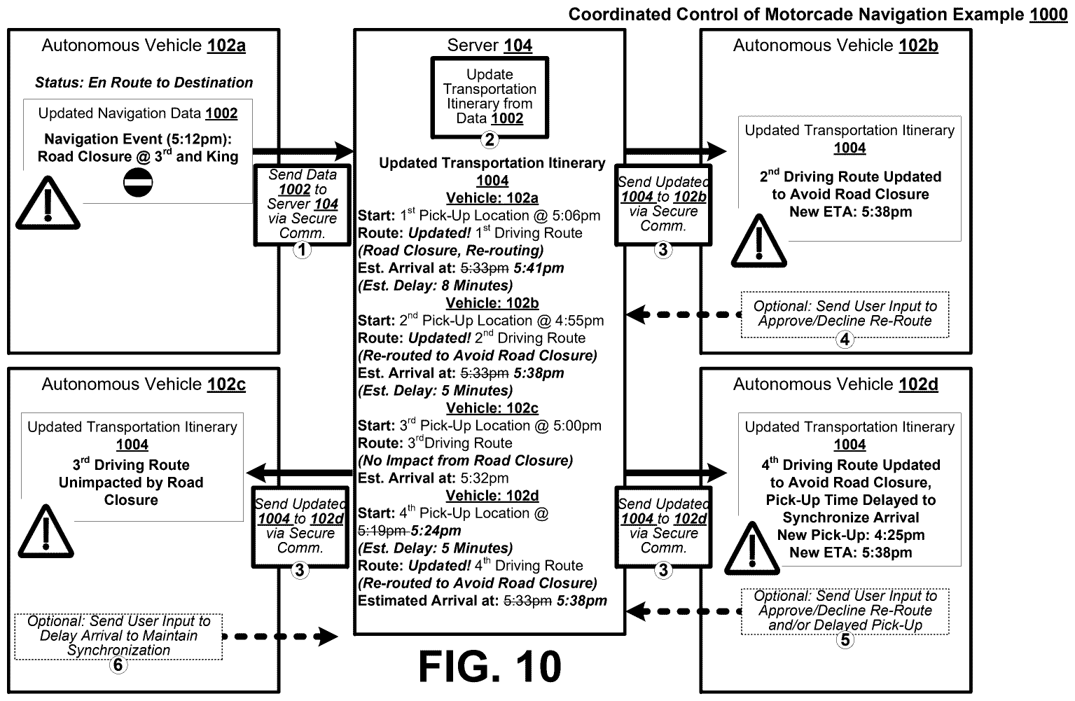

FIG. 10 illustrates an example 1000 representing the coordinated update of navigation and scheduling parameters across a motorcade following the example message flow of diagram 900C. In the example of FIG. 10, a transportation itinerary 1004 has been generated by the server 104 to define routing, pick-up locations, and travel timing for a set of autonomous vehicles 102a, 102b, 102c, and 102d. The original transportation itinerary 1004 specifies, for each vehicle, a designated pick-up location, pick-up time, driving route, and estimated time of arrival (ETA). Specifically, autonomous vehicle 102a is assigned to a 1^{st} driving route departing from a 1^{st} pick-up location; autonomous vehicle 102b is assigned to a 2^{nd} driving route departing from a 2^{nd} pick-up location; autonomous vehicle 102c is assigned to a 2^{rd} driving route departing from a 2^{rd} pick-up location; and autonomous vehicle 102d is assigned to a 4^{th} driving route departing from a 4^{th} pick-up location. The transportation itinerary 1004 is organized on a travel schedule such that vehicles 102a-102d are collectively planned to arrive at the shared destination within approximately one min. of one another, preserving temporal synchronization for the motorcade arrival event.

During execution of the plan, autonomous vehicle 102a is en route to the destination when updated navigation data 1002 is received, indicating that vehicle 102a has encountered a road closure at a particular intersection at 6:12 p.m. The updated navigation data 1002 is transmitted from the secure communication logic 162 of vehicle 102a to the secure communication interface 144 of the server 104, which logs and analyzes the report using the coordinated control logic 164. The server 104, upon receiving this information, uses it to revise the transportation itinerary 1004, as generally described in diagram 900C. In the illustrated example, the 1^{st} driving route assigned to vehicle 102a is re-routed to avoid the identified road closure, resulting in an updated driving route and an adjusted ETA delayed by approximately 8 min. relative to the original plan.

The server 104 then evaluates potential downstream impacts of the road closure on other vehicles in the motorcade. The system determines that vehicle 102b will encounter the same closure along its 2^{nd} driving route and accordingly generates an updated 2^{nd} driving route that avoids the affected intersection. The rerouting of vehicle 102b results in an estimated delay of approximately 5 min. In contrast, the 2^{rd} driving route assigned to vehicle 102c is determined not to be impacted by the road closure. Consequently, neither the route nor the ETA for vehicle 102c requires updating. However, in some implementations, participants within vehicle 102c may choose to maintain synchronized arrival with the remainder of the motorcade by voluntarily delaying their travel (e.g., by temporarily taking an off-route detour, pausing at a scenic point, or reducing cruising speed). This option allows the system to preserve coordinated group arrival even when a particular route segment is unaffected by traffic conditions that delay other vehicles.

The server 104 further determines that vehicle 102d is also scheduled to traverse the same affected area on its 4^{th} driving route. Accordingly, the server 104 updates the 4^{th} driving route for vehicle 102d to bypass the closure. The rerouted path for vehicle 102d is associated with an estimated five-min. travel delay. However, because vehicle 102d has not yet reached its 4^{th} pick-up location, and because its total route distance from pick-up to destination is shorter than that of the other vehicles, the system compensates by postponing the pick-up time by approximately five min. This timing adjustment prevents vehicle 102d from arriving at the destination prematurely and preserves the synchronized arrival window established across the motorcade. In some implementations, vehicles that have not yet begun travel (vehicle 102d in example 1000) can prompt user confirmation of itinerary changes through an end-user app 118 operating on a user device 108 associated with the passenger's account. The user may receive a push notification presenting details of the revised itinerary, including the delayed pick-up time and updated route, with options to approve or decline the proposed adjustments. In other implementations, for vehicles already en route (such as vehicle 102a) approval or acknowledgment may be provided via an in-vehicle user interface 322, enabling passengers to accept re-routing directly during travel. After any required approvals are received, the server 104 finalizes and disseminates the updated transportation itinerary 1004 to the motorcade vehicles. Each vehicle's secure communication logic 162 then forwards the updated itinerary to its respective E2E model 142, prompting the vehicles to implement the revised navigation parameters and timing offsets.

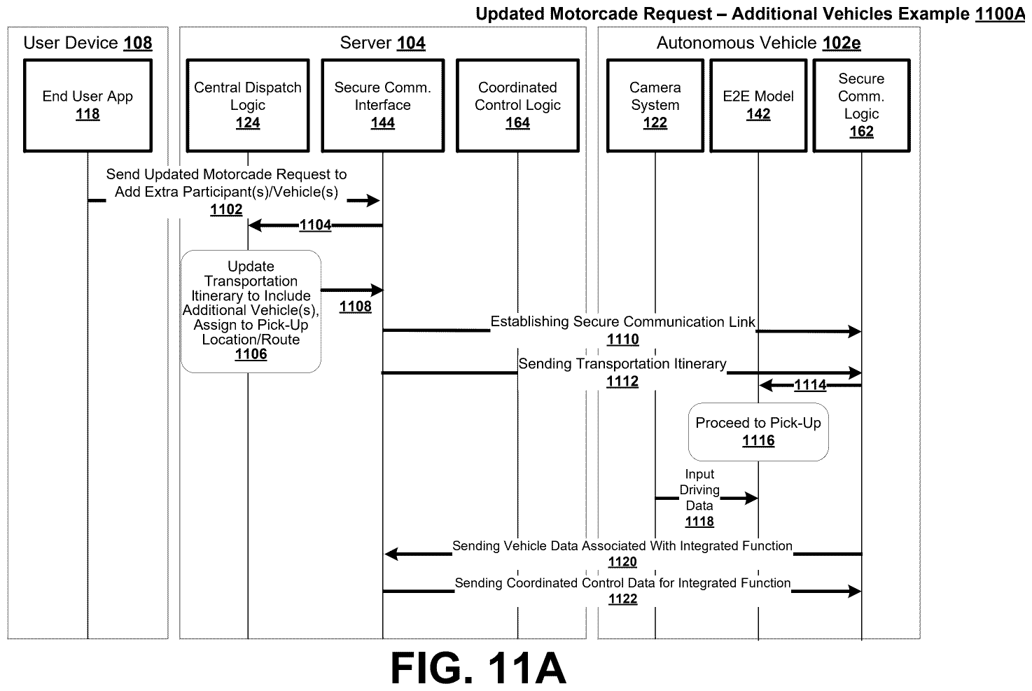

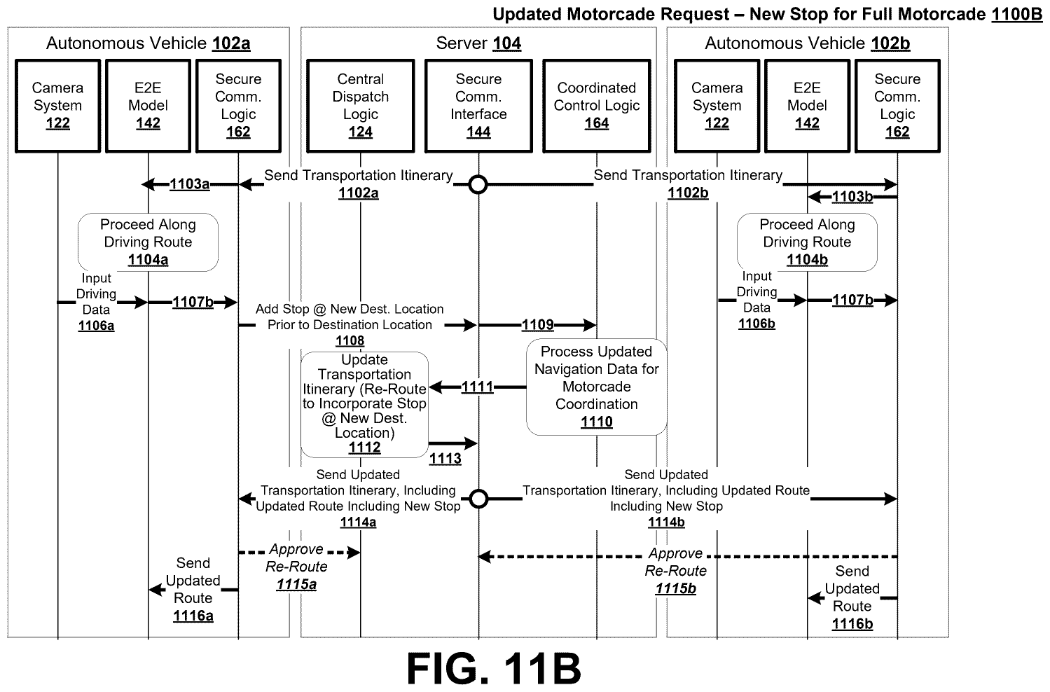

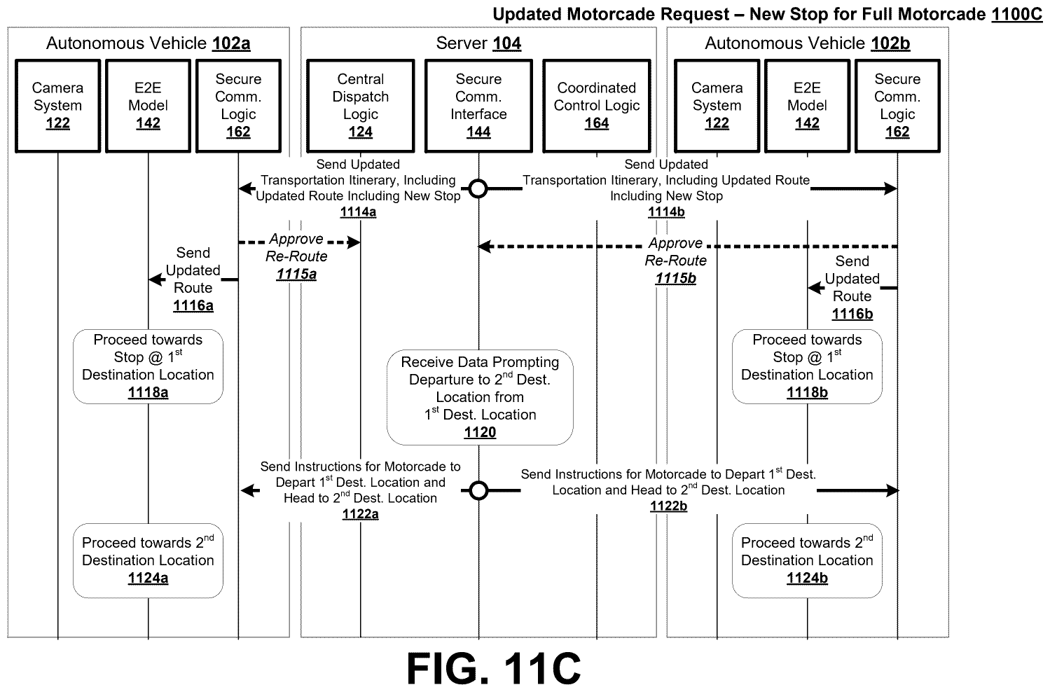

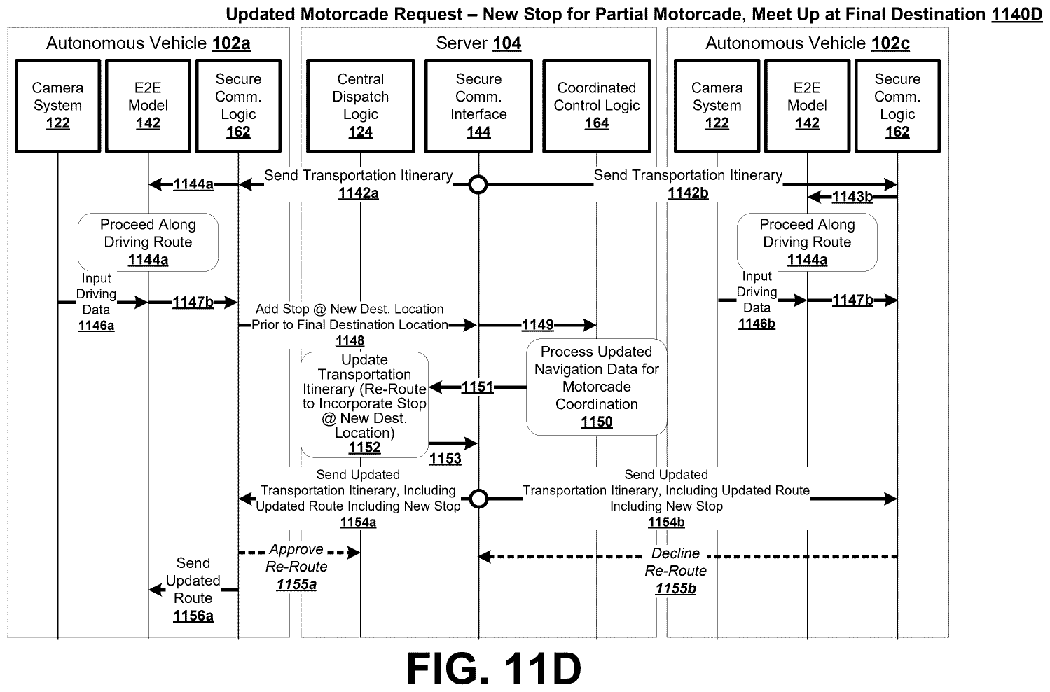

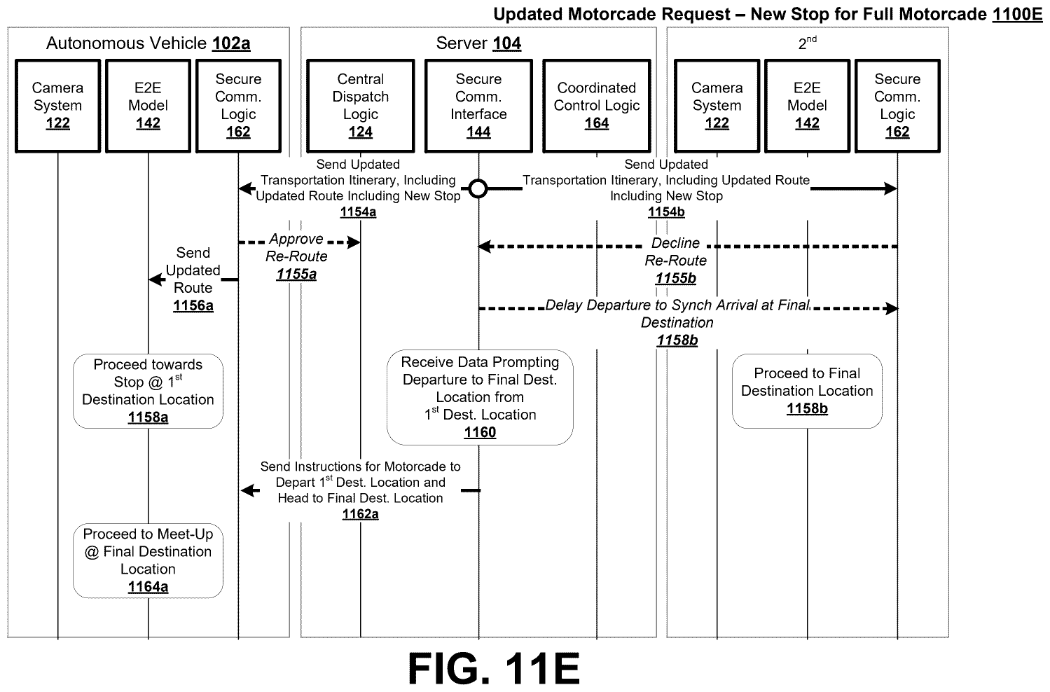

FIG. 11A shows a message flow diagram 1100A illustrating an updated motorcade request in which a user requests that the server 104 update an existing motorcade session to include one or more additional vehicles. At operation 1102, a user submits an updated motorcade request via an end-user app 118 operating on a user device 108. The request is transmitted to the server 104 through a secure network connection. In some implementations, the user explicitly specifies a number of additional autonomous vehicles 102 to be added to the motorcade. In other implementations, the user instead indicates an additional number of participants at one or more pick-up locations, and the central dispatch logic 124 automatically infers the required number of additional vehicles based on fleet capacity data (e.g., passenger limits or luggage constraints) to accommodate the expanded group.

The secure communication interface 144 of the server 104 receives the updated motorcade request in operation 1102 and forwards the request data to the central dispatch logic 124 in operation 1104. In operation 1106, the central dispatch logic 124 updates the transportation itinerary to integrate the requested additional vehicle(s) and assigns each to appropriate pick-up locations and corresponding driving routes based on the information provided in the updated motorcade request. The updated transportation itinerary is returned to the secure communication interface 144 in operation 1108, which then establishes a new secure communication link with each added vehicle. For example, the secure communication interface 144 establishes a link with additional autonomous vehicle 102e in operation 1110. Once the link is established, the secure communication interface 144 transmits the transportation itinerary to the secure communication logic 162 of autonomous vehicle 102e, enabling the vehicle to join the ongoing motorcade session with the necessary navigation and scheduling data.

The secure communication logic 162 within autonomous vehicle 102e passes the received itinerary data to its E2E autonomous-driving model 142 in operation 1114. The E2E model 142 processes the navigation data to determine the driving route and proceeds to the assigned pick-up location 1116 in operation 1116, ensuring arrival at the time designated for vehicle 102e in the updated transportation itinerary. As with other autonomous vehicles within the motorcade, vehicle 102e operates using a combination of driving-data inputs and navigation data received from the server 104 during the session. Autonomous vehicle 102e may transmit vehicle data associated with one or more integrated functions (e.g., navigation, communication, multimedia coordination, etc.) to the server 104 through the established secure link in operation 1120. Similarly, in operation 1122, autonomous vehicle 102e may receive coordinated control data from the server 104, allowing it to maintain synchronization with the other vehicles in the motorcade.

Referring now to FIG. 11B, a message-flow diagram 1100B is shown illustrating an updated motorcade request in which a user requests to modify the existing transportation itinerary by adding an additional destination location. The additional destination may be configured either as an intermediate stop prior to a final destination or as a replacement final destination superseding the previously scheduled endpoint. For example, participants may choose to stop at a grocery store before continuing to a social gathering, or may decide mid-journey to change their final destination from one event venue to another. Such requests may be submitted via an in-vehicle user interface 322 or through an end-user app 118 operating on a user device 108 associated with a participant.

In the example 1100B, the server 104 initially transmits the transportation itinerary to autonomous vehicle 102a in operation 1102a and to autonomous vehicle 102b in operation 1102b. The secure communication logic 162 of autonomous vehicle 102a provides the itinerary data to its E2E model 142 in operation 1103a, while the secure communication logic 162 of autonomous vehicle 102b provides the data to its E2E model 142 in operation 1103b. The transportation itinerary provides navigation parameters for both vehicles. The E2E model 142 of autonomous vehicle 102a receives input driving data from its camera system 122 in operation 1106a while proceeding along its assigned route in operation 1104a. Similarly, the E2E model 142 of autonomous vehicle 102b receives input driving data from its camera system 122 in operation 1106b while proceeding along its driving route in operation 1104b.

During travel, a participant in autonomous vehicle 102a initiates an updated motorcade request in operation 1108, requesting modification of the motorcade itinerary to incorporate an intermediate stop at a new destination location. The secure communication logic 162 transmits this updated request data to the server 104, where it is received by the secure communication interface 144 and passed to the coordinated control logic 164 in operation 1109. The coordinated control logic 164 processes the updated motorcade request in operation 1110, evaluating its implications for other vehicles in the motorcade, including potential route deviations and arrival-time impacts. The processed data is then forwarded to the central dispatch logic 124 in operation 1111. In operation 1112, the central dispatch logic 124 updates the transportation itinerary, generating new or re-routed driving routes that include the newly added intermediate stop or revised final destination. The updated itinerary is transmitted to the secure communication interface 144 in operation 1113, which distributes the data to autonomous vehicle 102a in operation 1114a and to autonomous vehicle 102b in operation 1114b via the established secure communication links.

In some implementations, participant confirmation may be required prior to executing the reroute. In operation 1115a, autonomous vehicle 102a transmits data to the server 104 indicating that the reroute has been approved by the onboard participants. Similarly, in operation 1115b, autonomous vehicle 102b transmits data indicating that its participants have also approved the updated route. In other implementations, either vehicle may implement the reroute automatically without awaiting explicit passenger consent, depending on predefined user preferences or system configuration. Following approval, the updated navigation data is transmitted from the secure communication logic 162 to the respective E2E models 142 of the vehicles in operation 1116a (for vehicle 102a) and operation 1116b (for vehicle 102b). The E2E models 142 update their internal navigation paths accordingly to include the new destination or modified route segment.

FIG. 11C is a message flow diagram 1100C that continues the example of diagram 1100B, illustrating the coordinated navigation of multiple vehicles after an itinerary update has been executed. For clarity and continuity, operations 1114a, 1114b, 1115a, 1115b, 1116a, and 1116b are reproduced at the top of diagram 1100C. In operation 1118a, the E2E model 142 of autonomous vehicle 102a proceeds along the newly re-routed driving path toward the intermediate stop at the 1^{st} destination location. Similarly, in operation 1118b, the E2E model 142 of autonomous vehicle 102b proceeds along its re-routed path toward the same intermediate stop. These operations reflect execution of the updated transportation itinerary distributed to the vehicles in diagram 1100B.

Upon arrival or when the intermediate stop parameters (e.g., duration or user confirmation) are satisfied, secure communication interface 144 receives data prompting departure of the motorcade from the 1^{st} destination location toward the 2^{nd} destination location in operation 1120. This departure prompt can originate from multiple sources depending on system configuration. In some implementations, the data received in operation 1120 is generated by the coordinated control logic 164 of the server 104 to maintain an overall travel schedule or synchronized progress among motorcade vehicles, including those that did not stop at the intermediate location. In other implementations, the prompt originates from a user interface 322 within one of the autonomous vehicles, or from an end-user app 118 operating on a user device 108 associated with a motorcade participant, indicating that the group is ready to proceed. In yet other embodiments, the departure prompt may be triggered automatically based on pre-determined data, such as scheduled arrival or departure times embedded in the transportation itinerary generated by the central dispatch logic 124.

Once the departure condition is met, the secure communication interface 144 transmits instructions in operations 1122a and 1122b, respectively, directing the motorcade vehicles to advance to the next leg of their driving routes toward the 2^{nd} destination location. In response, autonomous vehicle 102a advances toward the 2^{nd} destination in operation 1124a, while autonomous vehicle 102b advances toward the same destination in operation 1124b.

Referring now to FIG. 11D, a message flow diagram 1100D is shown depicting another example of an updated motorcade request in which participants make differing decisions regarding an itinerary modification. Specifically, the example demonstrates how the server 104 and vehicle control logic manage divergent approvals when one vehicle accepts a new route while another declines it. In some implementations, the additional destination location referenced in diagram 1100D may again represent an intermediate stop prior to continuing to a final destination. In other implementations, it may represent a replacement final destination superseding the prior endpoint defined during motorcade initialization. Many operations within diagram 1100D overlap with those described in FIG. 11B, and are thus summarized here rather than described at length for conciseness.

Analogously to operations 1122a and 1122b, the secure communication interface 144 sends the transportation itinerary to autonomous vehicles 102a and 102b in operations 1142a and 1142b, respectively. Following receipt, the secure communication logic 162 of autonomous vehicle 102a provides the itinerary data to its E2E model 142 in operation 1104a, and the secure communication logic 162 of autonomous vehicle 102b provides the itinerary data to its respective E2E model 142 in operation 1104b. The transportation itinerary provides navigation data for each vehicle, along with input driving data supplied by the respective camera systems 122 (received in operation 1146a for vehicle 102a and operation 1146b for vehicle 102b) to enable real-time environmental awareness and responsive driving control. Using these data inputs, each E2E model 142 navigates along its respective driving route in operations 1144a and 1144b, respectively.

At operation 1148, the secure communication logic 162 of autonomous vehicle 102a sends an updated motorcade request to the server 104, requesting to re-route its assigned path to incorporate an intermediate stop at a new destination location. The secure communication interface 144 receives the request and relays it to the coordinated control logic 164 in operation 1149. The coordinated control logic 164 processes the updated request data in operation 1150, analyzing its impact on timing, synchronization, and route alignment across the motorcade. The processed request data is then forwarded to the central dispatch logic 124 in operation 1151, which updates the transportation itinerary accordingly in operation 1152, generating new re-routed driving routes that incorporate the additional or modified destination. The updated transportation itinerary is returned to the secure communication interface 144 in operation 1153, which sends the updated data to autonomous vehicle 102a in operation 1154a and to autonomous vehicle 102b in operation 1154b via the established secure communication links.

Autonomous vehicle 102a transmits data to the server 104 in operation 1155a indicating approval of the re-route, whereas autonomous vehicle 102b transmits data in operation 1155b indicating that the re-route has been declined by its participants. The server 104, upon receiving these differing inputs, maintains the re-routed itinerary for vehicle 102a while preserving the prior route and destination for vehicle 102b. Accordingly, autonomous vehicle 102a provides the updated route data to its E2E model 142 in operation 1156a, implementing the new navigation parameters. Autonomous vehicle 102b, by contrast, retains its prior navigation configuration and does not forward the updated route data to its E2E model 142.

FIG. 11E is a message flow diagram 1100E that continues from diagram 1100D, illustrating progression of the vehicles after an itinerary modification where some participants accepted and others declined an intermediate stop. For convenience and clarity, operations 1154a, 1154b, 1155a, 1155b, 1156a, and 1156b are reproduced at the top of diagram 1100E. In operation 1158a, the E2E model 142 of autonomous vehicle 102a proceeds toward the intermediate stop at the 1^{st} destination location, following the updated route accepted by its passengers. Because the participants of autonomous vehicle 102b declined the additional stop, vehicle 102b continues under its original transportation itinerary and is scheduled to rendezvous with vehicle 102a at the final destination location as initially planned.

Optionally, the departure time of autonomous vehicle 102d (another vehicle within the motorcade) may be delayed in operation 1158b to maintain synchronized arrival with vehicle 102a at the final destination. This adaptive timing preserves coordinated group arrival across vehicles with differing route histories or stop patterns. When autonomous vehicle 102a has completed the intermediate stop or the pre-set duration of stay expires, the secure communication interface 144 receives data prompting departure in operation 1160, directing the vehicle to proceed toward the final destination. The data received in operation 1160 may originate from multiple sources. In some implementations, it is generated automatically by the coordinated control logic 164 to preserve a travel schedule or synchronized arrival window relative to autonomous vehicle 102b. In other implementations, the prompt originates from a user interface 322 within the vehicle or from an end-user app 118 on a user device 108 associated with a participant, signaling that the group is ready to depart. In yet other implementations, the prompt is triggered by pre-determined data, such as scheduled departure or arrival times contained within the transportation itinerary generated by the central dispatch logic 124.

Responsive to this prompt, the secure communication interface 144 issues instructions in operation 1162a directing autonomous vehicle 102a to advance along the next leg of its driving route toward the final destination location. The E2E model 142 executes the updated route, and vehicle 102a proceeds accordingly in operation 1164a. In parallel, autonomous vehicle 102b advances toward the final destination location in operation 1158b. In certain implementations, vehicle 102b initiates departure based on the same data that triggered vehicle 102a's departure from the intermediate stop or upon receiving data confirming that vehicle 102a has departed.

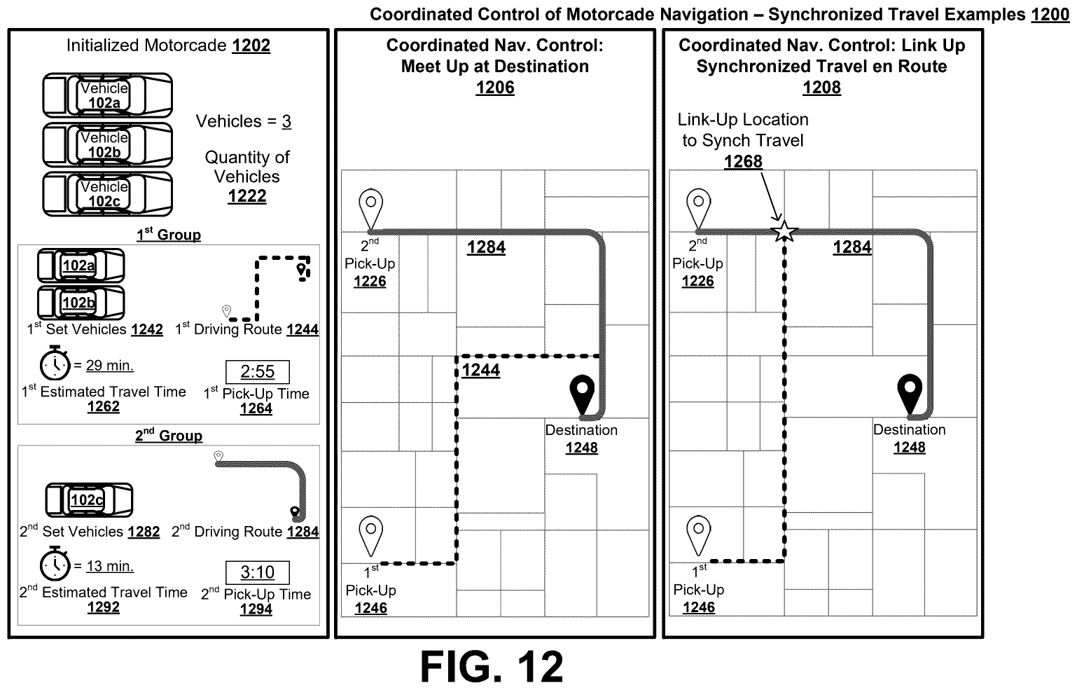

FIG. 12 illustrates an example 1200 depicting synchronized travel of multiple autonomous vehicles within a motorcade through coordinated control of navigation functions. The examples demonstrate how the motorcade 100 establishes timing, routing, and link-up coordination among vehicles following distinct itineraries, in accordance with certain implementations. Autonomous convoying techniques are discussed further in, e.g., S. Nahavandi et al., “Autonomous Convoying: A Survey on Current Research and Development,” in IEEE Access, vol. 10, pp. 13663-13683, 2022, doi: 10.1109/ACCESS.2022.3147251, which is hereby incorporated by reference.

An initialized motorcade 1202 is shown including a motorcade 1222 of three autonomous vehicles (102a, 102b, and 102c) each operating under a shared transportation itinerary. The transportation itinerary defines a 1^{st} group of participants to be picked up by a 1^{st} set of autonomous vehicles 1242, including vehicle 102a and vehicle 102b. This 1^{st} set is assigned to a 1^{st} driving route 1244, traveling from a 1^{st} pick-up location 1246 to a destination 1248. The 1^{st} estimated travel time 1262 for the 1^{st} driving route 1244 is approximately 29 min., and the 1^{st} pick-up time 1264 is set to 2:55 p.m. The itinerary further includes a 2^{nd} group of participants to be picked up by a 2^{nd} set of autonomous vehicles 1282, here consisting of autonomous vehicle 102c. The 2^{nd} set 1282 is assigned to a 2^{nd} driving route 1284, extending from a 2^{nd} pick-up location 1226 to the same destination 1248. The 2^{nd} estimated travel time 1292 for the 2^{nd} driving route 1284 is approximately 13 min., and the 2^{nd} pick-up time 1294 is scheduled for 3:10 p.m. In example 1206, the coordinated navigation control of the motorcade results in the 1^{st} set of autonomous vehicles 1222 arriving and linking with the 2^{nd} set 1282 at the destination 1248 simultaneously, thereby maintaining synchronized arrival despite differing route lengths and departure times. This synchronization may be achieved through dynamic adjustment of departure times, adaptive speed control, or micro-delays introduced by the coordinated control logic 164 to maintain temporal alignment across the fleet.

Alternatively, example 1208 illustrates a configuration in which the motorcade achieves coordination through an link-up location 1268, allowing multiple vehicle groups to merge into a unified formation before reaching the destination. At this link-up location, vehicles traveling from different pick-up origins can converge and proceed as a single synchronized convoy for the remainder of the route. The coordinated control logic 164, working in conjunction with the central dispatch logic 124, dynamically adjusts routing and timing parameters to facilitate this convergence, ensuring that vehicles reach the link-up point within a defined tolerance (e.g., within one min. of each other, within a defined time window, or based on real-time navigation data). In implementations involving coordinated, close-range motorcade navigation, the vehicles can leverage V2V communication to share data.

### Integrated Passenger Communication and Shared Multimedia Entertainment Examples

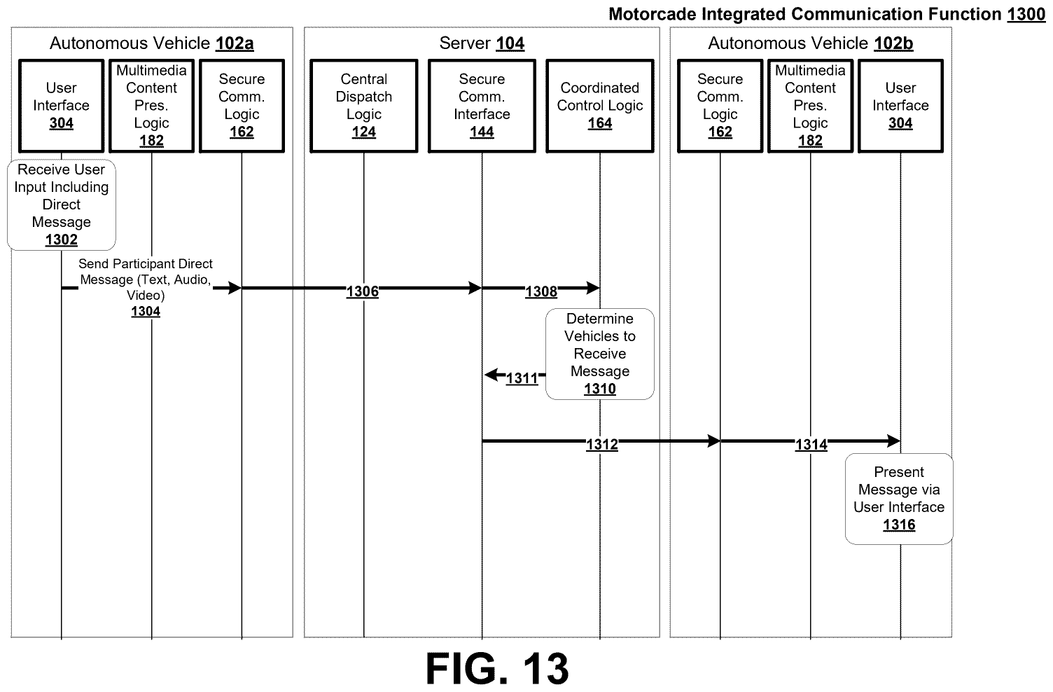

The discussion now turns to implementations of the technology disclosed wherein the motorcade provides integrated communication and multimedia functionality that allows participants across multiple vehicles to interact, share information, and enjoy synchronized entertainment experiences. FIG. 13 is a message-flow diagram 1300 illustrates an integrated communication function of the motorcade, enabling participants in separate vehicles to exchange messages, initiate live calls, or share media through secure, server-coordinated links. In operation 1302, a user interface 304 of an autonomous vehicle 102a within the motorcade receives user input that includes a direct message from a participant on board vehicle 102a, intended for delivery to at least one other vehicle, such as autonomous vehicle 102b. The direct message can take various forms, including a text message entered through a chat interface, an audio recording, a photo message, or a video message. The communication feature may operate as a real-time or near-real-time chat, an audio call streaming live across two or more vehicles, or a video call allowing live audiovisual communication between participants in different vehicles.

After the message is entered, it is provided from the user interface 304 to the secure communication logic 162 of autonomous vehicle 102a in operation 1304. The secure communication logic 162 transmits the message to the secure communication interface 144 of the server 104 in operation 1306, where the message is securely received and logged. The secure communication interface 144 then provides the message data to the coordinated control logic 164 in operation 1308, allowing the server to determine which vehicles within the motorcade should receive the message and, optionally, when and how the message should be delivered (for example, immediately, upon arrival at a destination, or during a synchronized event). In operation 1310, the coordinated control logic 164 processes this data in order to identify target vehicles and any delivery timing parameters, and returns the processed message data to the secure communication interface 144. The secure communication interface 144 transmits the participant message to autonomous vehicle 102b via the secure link in operation 1312, and may also distribute the same message to additional vehicles in the motorcade (not shown in FIG. 13 for clarity).

At the receiving end, the secure communication logic 162 of autonomous vehicle 102b forwards the message to its user interface 304 in operation 1314, enabling the message to be presented (e.g., displayed, played, or otherwise rendered) to participants on board vehicle 102b. This coordinated message flow ensures secure, authenticated, and synchronized communication among all participants in the motorcade, supporting text, voice, and multimedia exchanges over a resilient, server-orchestrated communication network.

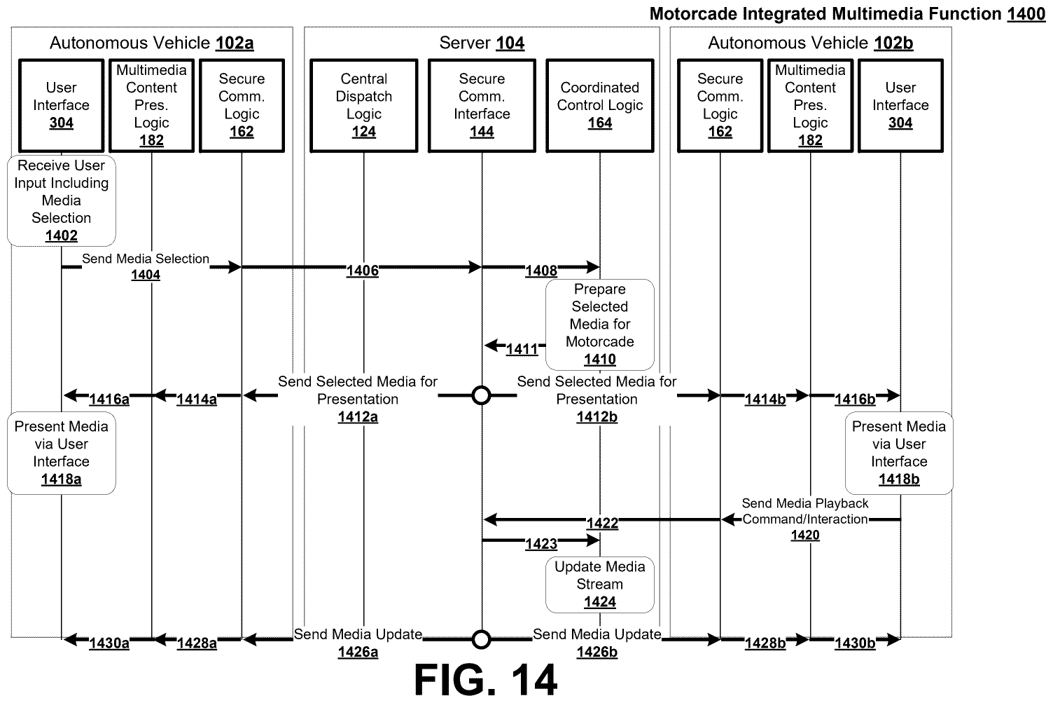

FIG. 14 shows a message-flow diagram 1400 illustrating an integrated multimedia function of the motorcade, enabling participants to enjoy synchronized media playback, interactive content, or group entertainment across multiple vehicles. In operation 1402, the user interface 304 of autonomous vehicle 102a receives a user input specifying a selected media item, such as a music track, video, or interactive game or activity, for presentation across one or more vehicles 102 in the motorcade. The user interface 304 transmits the media selection to the secure communication logic 162 of vehicle 102a in operation 1404, which in turn sends the data to the secure communication interface 144 of the server 104 in operation 1406. In operation 1408, the secure communication interface 144 provides the media-selection data to the coordinated control logic 164, which in operation 1410 prepares the selected media for coordinated presentation across the motorcade. The preparation process may involve synchronizing playback timing, optimizing streaming quality based on bandwidth, or encoding the media stream into multiple presentation formats.

The coordinated control logic 164 then transmits the prepared data back to the secure communication interface 144 in operation 1411, which distributes the data to the vehicles in the motorcade. For instance, in operations 1412a and 1412b, the secure communication interface 144 sends the prepared media data to the secure communication logic 162 of autonomous vehicles 102a and 102b, respectively. The transmitted data may include the media stream itself or the information necessary to obtain or render the media content from a shared source.

Each vehicle's secure communication logic 162 forwards the received data to its respective multimedia content presentation logic 182, e.g., in operation 1414a for vehicle 102a and operation 1414b for vehicle 102b. The multimedia content presentation logic 182 processes and sends the media for display on the user interface 304 of the vehicle in operations 1416a and 1416b, respectively. The user interface 304 then presents the media content to participants in operations 1418a and 1418b, such as by playing a synchronized song, video, or shared visual animation across vehicles. Participants may also interact with the media presentation. For example, in operation 1420, the user interface 304 of autonomous vehicle 102b receives a media playback command or interaction (such as play, pause, rewind, skip, change content, a passenger reaction to the media, or user input for an interactive game) and transmits this input to the secure communication logic 162.

The secure communication logic 162 sends the interaction data to the secure communication interface 144 of the server 104 in operation 1422, which forwards the data to the coordinated control logic 164 in operation 1423. The coordinated control logic 164 then updates the shared media stream based on the received input in operation 1424, for instance by applying playback adjustments, registering reactions, or altering shared game state data. The updated media stream or interaction response is distributed back to the motorcade vehicles. The secure communication interface 144 sends media-update data to autonomous vehicle 102a in operation 1426a and to autonomous vehicle 102b in operation 1426b. Secure communication logic 162 relays the update to the multimedia content presentation logic 182, in operations 1428a and 1428b, respectively. The multimedia content presentation logic 182 outputs the revised or synchronized media content to the user interface 304 of each vehicle (shown in operations 1430a and 1430b) so that the updated content is presented concurrently across all vehicles.

### Computer System

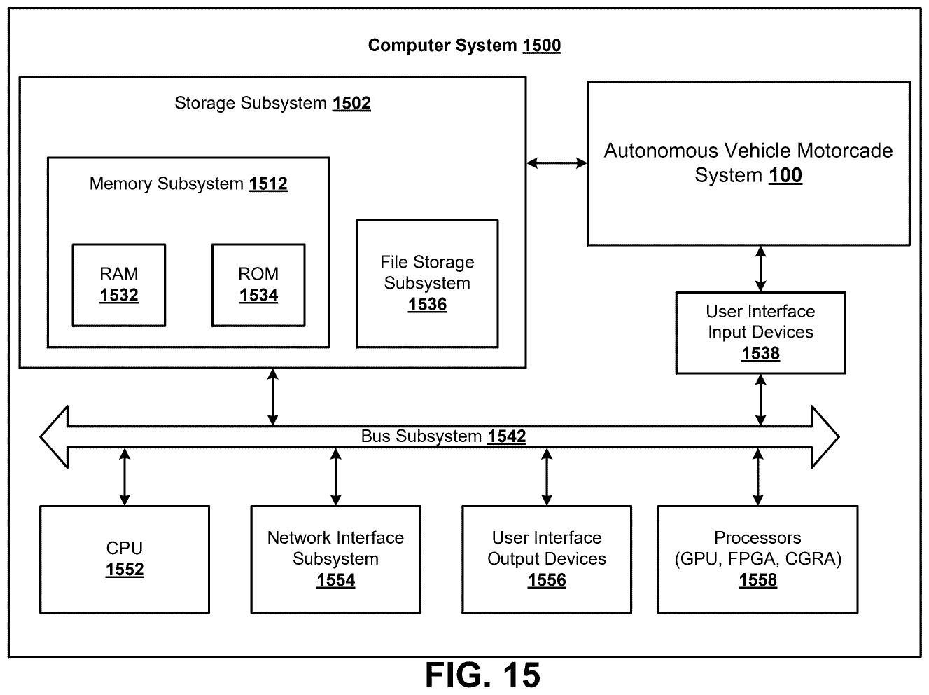

FIG. 15 illustrates a computer system 1500 that can be used to implement the technology disclosed, in accordance with certain implementations of the present disclosure. Computer system 1500 includes at least one central processing unit (CPU) 1552 that communicates with a number of peripheral devices via bus subsystem 1542. These peripheral devices can include a storage subsystem 1502 including, for example, memory devices and a file storage subsystem 1536, user interface input devices 1538, user interface output devices 1556, and a network interface subsystem 1554. The input and output devices allow user interaction with computer system 1500. Network interface subsystem 1554 provides an interface to outside networks, including an interface to corresponding interface devices in other computer systems.

In one implementation, system 100 is communicably linked to the storage subsystem 1502 and the user interface input devices 1538. In another implementation, the control unit 1526 of the depot and the control unit 1532 of the transporter are also communicably linked to the storage subsystem 1502 and the user interface input devices 1538. User interface input devices 1538 can include a keyboard; pointing devices such as a mouse, trackball, touchpad, or graphics tablet; a scanner; a touch screen incorporated into the display; and audio input devices such as voice recognition systems and microphones. In general, use of the term “input device” is intended to include all possible types of devices and ways to input information into computer system 1500.

User interface output devices 1556 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1500 to the user or to another machine or computer system.

Storage subsystem 1502 stores programming and data constructs that provide the functionality of some or all of the modules and methods described herein. These software modules are generally executed by processors 1558. Processors 1558 can be graphics processing units (GPUs), field-programmable gate arrays (FPGAs), application-specific integrated circuits (ASICs), and/or coarse-grained reconfigurable architectures (CGRAs). Processors 1558 can be hosted by a deep learning cloud platform such as Google Cloud Platform™, Xilinx™, and Cirrascale™. Examples of processors 1578 include Google's Tensor Processing Unit (TPU)™, rackmount solutions like GX4 Rackmount Series™, GX16 Rackmount Series™, NVIDIA DGX-1™, Microsoft' Stratix V FPGA™, Graphcore's Intelligent Processor Unit (IPU)™, Qualcomm's Zeroth Platform™ with Snapdragon processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, Lambda GPU Server with Testa V100s™, and others.

Memory subsystem 1512 used in the storage subsystem 1502 can include a number of memories including a main random access memory (RAM) 1532 for storage of instructions and data during program execution and a read only memory (ROM) 1534 in which fixed instructions are stored. A file storage subsystem 1536 can provide persistent storage for program and data files, and can include a hard disk drive, a floppy disk drive along with associated removable media, a CD-ROM drive, an optical drive, or removable media cartridges. The modules implementing the functionality of some implementations can be stored by file storage subsystem 1536 in the storage subsystem 1502, or in other machines accessible by the processor. Bus subsystem 1542 provides a mechanism for letting the various components and subsystems of computer system 1500 communicate with each other as intended. Although bus subsystem 1542 is shown schematically as a single bus, alternative implementations of the bus subsystem can use multiple busses.

Computer system 1500 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 1500 depicted in FIG. 15 is intended only as a specific example for purposes of illustrating the preferred implementations of the present invention. Many other configurations of computer system 1500 are possible having more or less components than the computer system depicted in FIG. 15.

Each of the processors or modules discussed herein may include an algorithm (e.g., instructions stored on a tangible and/or non-transitory computer readable storage medium) or sub-algorithms to perform particular processes. System 100 is illustrated conceptually as a collection of modules, but may be implemented utilizing any combination of dedicated hardware boards, DSPs, processors, etc. Alternatively, system 100 may be implemented utilizing an off-the-shelf PC with a single processor or multiple processors, with the functional operations distributed between the processors. As a further option, the modules described below may be implemented utilizing a hybrid configuration in which some modular functions are performed utilizing dedicated hardware, while the remaining modular functions are performed utilizing an off-the-shelf PC and the like. The modules also may be implemented as software modules within a processing unit.

Various processes and steps of the methods set forth can be carried out using a computer. The computer can include a processor that is part of a detection device, networked with a detection device used to obtain the data that is processed by the computer or separate from the detection device. In some implementations, information (e.g., image data) may be transmitted between components of a system disclosed herein directly or via a computer network. A local area network (LAN) or wide area network (WAN) may be a corporate computing network, including access to the Internet, to which computers and computing devices comprising the system are connected. In one implementation, the LAN conforms to the transmission control protocol/internet protocol (TCP/IP) industry standard. In some instances, the information (e.g., image data) is input to a system disclosed herein via an input device (e.g., disk drive, compact disk player, USB port etc.). In some instances, the information is received by loading the information, e.g., from a storage device such as a disk or flash drive. A processor that is used to run an algorithm or other process set forth herein may comprise a microprocessor. The microprocessor may be any conventional general purpose single-or multi-chip microprocessor such as a Pentium™ processor made by Intel Corporation. A particularly useful computer can utilize an Intel Ivybridge dual-16 core processor, LSI raid controller, having 168 GB of RAM, and 2 TB solid state disk drive. In addition, the processor may comprise any conventional special purpose processor such as a digital signal processor or a graphics processor. The processor typically has conventional address lines, conventional data lines, and one or more conventional control lines.

The preceding description is presented to enable the making and use of the technology disclosed. Various modifications to the disclosed implementations will be apparent, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein. The scope of the technology disclosed is defined by the appended claims.

### Particular Implementations

Many implementations of the technology disclosed relate to methods of coordinating multiple autonomous vehicles for group transportation, including: receiving, at a server, a motorcade formation request from an end user application operating on a 1^{st} user device, wherein the motorcade formation request includes a quantity of participants in the motorcade, at least one pick-up location, and a destination location, and initializing a motorcade session, by the server, based on the motorcade formation request. Initialization of the motorcade session can include determining a quantity of autonomous vehicles for use in the motorcade based on the quantity of participants in the motorcade, wherein each autonomous vehicle further includes an E2E autonomous driving model to autonomously operate actuation signals of the vehicle in response to an instruction of a driving route, a GNSS feed, a video feed, and a LiDAR feed; assigning a 1^{st} set of the autonomous vehicles to pick up a 1^{st} group of the participants at a 1^{st} pick-up location; and generating a transportation itinerary for the motorcade including a 1^{st} driving route to the destination location from the 1^{st} pick-up location and a 1^{st} estimated travel time of the 1^{st} driving route. The method can further include starting the motorcade session, wherein the motorcade session includes the server establishing secure communication links with the autonomous vehicles in the motorcade and sending the transportation itinerary to the autonomous vehicles within the motorcade; and facilitating, by the server, coordinated control within the motorcade of at least one of an integrated navigation function, an integrated communication function, and an integrated multimedia function, wherein the facilitating of the coordinated control further includes the server processing data associated with at least one autonomous vehicle within the motorcade and communicating with at least one other autonomous vehicle within the motorcade based on the processed data.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified as implementations.

In some implementations, the server facilitating coordinated control of the integrated navigation function includes: receiving data from a 1^{st} autonomous vehicle within the motorcade indicating an updated traffic pattern at the location of the 1^{st} autonomous vehicle; processing the data and updating the transportation itinerary for the motorcade based on the processed data; and sending an updated transportation itinerary to the other autonomous vehicles within the motorcade, wherein the updated transportation itinerary includes an updated driving route or an updated estimated travel time of the driving route. In other implementations, the initializing of the motorcade session further includes: assigning a 2^{nd} set of the autonomous vehicles to pick up a 2^{nd} group of the participants at a 2^{nd} pick-up location, wherein the generated transportation itinerary further includes a 2^{nd} driving route to the destination location from the 2^{nd} pick-up location and a 2^{nd} estimated travel time of the 2^{nd} driving route. Some disclosed methods further include determining, based on the 1^{st} estimated travel time of the 1^{st} driving route and the 2^{nd} estimated travel time of the 2^{nd} driving route, a 1^{st} pick-up time for the 1^{st} set of autonomous vehicles at the 1^{st} pick-up location and a 2^{nd} pick-up time for the 2^{nd} set of autonomous vehicles at the 2^{nd} pick-up location such that an estimated 1^{st} arrival time of the 1^{st} set of autonomous vehicles at the destination location and an estimated 2^{nd} arrival time of the 2^{nd} set of autonomous vehicles at the destination location are within a pre-defined window of time duration.

Other implementations of the technology disclosed relate to any of the aforementioned computer-implemented methods, wherein the 1^{st} pick-up time for the 1^{st} set of autonomous vehicles occurs earlier than the 2^{nd} pick-up time for the 2^{nd} set of autonomous vehicles, and the server facilitating coordinated control of the integrated navigation function includes: receiving data from a 1^{st} autonomous vehicle within the 1^{st} set of autonomous vehicles indicating an extension of the 1^{st} estimated travel time of the 1^{st} driving route, wherein the extended 1^{st} estimated travel time of the 1^{st} driving route results in an updated 1^{st} arrival time at the destination location such that the updated 1^{st} arrival time occurs outside of the pre-defined window of time duration; updating the transportation itinerary for the motorcade based on the processed data, including updating the 2^{nd} pick-up time at the 2^{nd} pick-up location such that the updated 1^{st} arrival time and an updated 2^{nd} arrival time are within the pre-defined window of time duration; and sending the updated transportation itinerary to the autonomous vehicles within the motorcade. In another implementation, the server facilitating coordinated control of the integrated navigation function includes receiving, at a server, a transportation itinerary update request, wherein the transport itinerary update request includes an updated destination location; updating the transportation itinerary based on the transportation itinerary update request, including updating respective driving routes and respective estimated travel times of the respective updated driving routes based on a current location of the autonomous vehicles; and sending the updated transportation itinerary to the autonomous vehicles within the motorcade, wherein at least one autonomous vehicle within the motorcade is re-routed to the updated driving route to the updated destination location based on the updated transportation request. In another implementation, at least one autonomous vehicle within the motorcade is instructed, by the server or a participant in the motorcade, to ignore the updated driving route to the updated destination location and remain on an existing driving route to the destination location.

Some disclosed methods include the server facilitating coordinated control of an integrated communication function. The server facilitating coordinated control of the integrated communication function can include receiving, at a server, a participant direct message received from a user interface of an autonomous vehicle within the motorcade, wherein the participant direct message includes at least one of text data, image data, audio data, or video data; and sending, by the server to the autonomous vehicles within the motorcade, the participant direct message to enable the autonomous vehicles within the motorcade to present the participant direct message via respective user interfaces of the autonomous vehicles within the motorcade. The disclosed methods can further include sending, by the server to the end user application operating on a user device associated with a participant in any particular autonomous vehicle within the motorcade, the participant direct message to enable the end user application to present the participant direct message via the user device associated with the participant.

In yet another implementation, the server facilitating coordinated control of the integrated communication function includes: receiving, at a server, a participant direct message received the end user application operating on a user device associated with a participant in any particular autonomous vehicle within the motorcade, wherein the participant direct message includes at least one of text data, image data, audio data, or video data; and sending, by the server to the autonomous vehicles within the motorcade, the participant direct message to enable the autonomous vehicles within the motorcade to present the participant direct message via respective user interfaces of the autonomous vehicles within the motorcade. In some implementations, the integrated communication function includes a live calling feature including the server facilitating real time or near-real time streaming of live audio or a live video across at least two of the autonomous vehicles within the motorcade. In many implementations, the disclosed method includes the server facilitating coordinated control of the integrated multimedia function, including: receiving, from a participant via either a user interface in an autonomous vehicle within a motorcade or the end user application operating on a user device associated with the participant, media content capable of being presented on a user interface of the autonomous vehicles within the motorcade; and sending, by the server to the autonomous vehicles within the motorcade, data enabling the autonomous vehicles to present the media content via the respective user interfaces of the autonomous vehicles within the motorcade; wherein the media content includes one or more of audio data, video data, image data, or interactive entertainment data.

In certain implementations, the server facilitating coordinated control of the integrated multimedia function includes: streaming, to the autonomous vehicles within the motorcade, a media content stream enabling the autonomous vehicles to present the media content stream via respective user interfaces of the autonomous vehicles within the motorcade; receiving, from a participant via either a user interface in an autonomous vehicle within a motorcade or the end user application operating on a user device associated with the participant, a user input related to the media content stream including: a playback command to pause, resume, rewind, fast forward, or skip a portion of the media content stream, a command to terminate the media content stream, a command to switch from the media content stream to a new media content stream, an input command to take an action within an interactive feature or gaming feature of the media content stream, or a reaction input indicating a particular emotive reaction based on the media content stream; and sending, to the autonomous vehicles, an update to the media content stream based on the user input.

In other implementations, the server facilitating coordinated control of the integrated multimedia function includes: streaming, to a particular autonomous vehicle within the motorcade, a 1^{st} media content stream enabling the particular autonomous vehicle to present the 1^{st} media content stream via a user interface of the particular autonomous vehicle; streaming, to another particular autonomous vehicle within the motorcade, a 2^{nd} media content stream enabling the other particular autonomous vehicle to present the 2^{nd} media content stream via a user interface of the other particular autonomous vehicle; and receiving, from the particular autonomous vehicle, a request to switch from the 1^{st} media content stream to the 2^{nd} media content stream; and streaming, to the particular autonomous vehicle, the 2^{nd} media content stream enabling the particular autonomous vehicle to present the 2^{nd} media content stream, in real time or near-real time synchronization with the other particular autonomous vehicle, via the user interface of the particular autonomous vehicle. In one disclosed implementation, the server facilitating coordinated control of the integrated multimedia function includes: sending, to the autonomous vehicles within the motorcade, data controlling an aesthetic feature of the respective autonomous vehicles within the motorcade to synchronize the aesthetic feature across the motorcade, wherein the aesthetic feature is an external or internal lighting display parameter.

Another disclosed method relates to an autonomous vehicle participating in a coordinated motorcade session. The autonomous vehicle establishes a secure communication link with the server, receives transportation-itinerary data including a driving route, estimated travel time, and assigned pickup location, and provides this data to an E2E model that generates actuation signals for vehicle control. The autonomous vehicle transmits updated navigation or vehicle-status data to a server or other vehicles in the motorcade and receives coordinated-control data to maintain synchronized operation with other vehicles in the motorcade. Passenger inputs or media selections can also be transmitted to the server or other vehicles for shared interaction. The autonomous vehicle functions as an intelligent node in a distributed control framework, executing autonomous driving locally while participating in motorcade coordination. This method can be combined with features disclosed in the implementations above and throughout this application which are not individually enumerated or repeated with the set of training features. The reader will understand how features identified in this section can readily be combined with sets of base features identified as implementations.

Some implementations of the technology disclosed include a system for coordinating multiple autonomous vehicles for group transportation, the system including a server and a fleet of autonomous vehicles. In certain implementations, the system further includes multimedia services. In some implementations, the system further includes an end-user application operating on a user device. The server can further include a central dispatch logic to receive a motorcade formation request, initialize a motorcade session based on the motorcade formation request, wherein initializing the motorcade includes determining autonomous vehicles for use in the motorcade and generating a transportation itinerary for the motorcade, and update the transportation itinerary based on updated data associated with an autonomous vehicle within the motorcade, a secure communication interface to facilitate bi-directional communication with the autonomous vehicles within the motorcade, and a coordinated control logic capable to facilitate coordinated control of an integrated function across the autonomous vehicles within the motorcade including processing data associated with at least one autonomous vehicle within the motorcade and communicating with at least one other autonomous vehicle within the motorcade based on the processed data.

The autonomous vehicle (e.g., within a motorcade) can further include an end-to-end autonomous driving model to autonomously operate actuation signals of the vehicle in response to an instruction of a driving route, a GNSS feed, a video feed, and a LiDAR feed, a secure communication logic to bi-directionally communicate with the server, a multimedia content presentation logic to present media content to participants using the motorcade; a user interface to receive user input for participant direct messaging and display participant direct messages received by the secure communication logic, display the media content presented by the multimedia content presentation logic, and receive user input for interacting with the presented media content; an external programmable LED lighting display; and an internal programmable LED lighting display.

In many implementations, the server facilitates coordinated control of an integrated navigation function, the coordinated control of the integrated navigation function including: the coordinated control logic processing updated navigation data, received by the secure communication interface from a 1^{st} autonomous vehicle within the motorcade; the central dispatch logic updating the transportation itinerary based on the updated navigation data; and the secure communication interface sending an updated transportation itinerary to the other autonomous vehicles within the motorcade, wherein the updated transportation itinerary includes an updated driving route or an updated estimated travel time of the driving route. In other implementations, the server facilitates coordinated control of an integrated communication function, the coordinated control of the integrated communication function including: receiving, by the secure communication interface, a participant direct message received from a user interface of an autonomous vehicle within the motorcade, wherein the participant direct message includes at least one of text data, image data, audio data, or video data; and sending, by the secure communication interface to the autonomous vehicles within the motorcade, the participant direct message to enable the autonomous vehicles within the motorcade to present the participant direct message via respective user interfaces of the autonomous vehicles within the motorcade.

One implementation includes coordinated control of the integrated multimedia function, including streaming, to the autonomous vehicles within the motorcade, a media content stream enabling the respective multimedia content presentation logics of the autonomous vehicles to present the media content stream via the respective user interfaces of the autonomous vehicles within the motorcade; receiving, from a participant via either the user interface or an end user application operating on a user device associated with the participant, a user input related to the media content stream including: a playback command to pause, resume, rewind, fast forward, or skip a portion of the media content stream, a command to terminate the media content stream, a command to switch from the media content stream to a new media content stream, an input command to take an action within an interactive feature or gaming feature of the media content stream, or a reaction input indicating a particular emotive reaction based on the media content stream; and sending, to the autonomous vehicles, an update to the media content stream based on the user input.

The technology disclosed can be practiced as a system, method, or article of manufacture. For instance, the technology disclosed can be practiced as a system with a hardware processor, memory coupled to the processor, and instructions executable on the processor that, when executed, cause the system to carry out any of the methods described. Such a system can include connected sensors from which the environmental data are received. Similarly, the technology disclosed can be practiced as computer readable medium impressed with instructions executable on a hardware processor that, when executed, cause a system including the processor to carry out any of the methods described. Such a computer readable medium impressed with instructions for receiving environmental data from sensors. While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following claims.

What is claimed is:

1. A computer-implemented method of coordinating multiple autonomous vehicles for group transportation, including:
receiving, at a server, a motorcade formation request from an end user application operating on a first user device, wherein the motorcade formation request includes a quantity of participants in the motorcade, at least one pick-up location, and a destination location;
initializing a motorcade session, by the server, based on the motorcade formation request, the initializing of the motorcade session including:
determining a quantity of autonomous vehicles for use in the motorcade based on the quantity of participants in the motorcade, wherein each autonomous vehicle further includes an end-to-end autonomous driving model to autonomously operate actuation signals of the vehicle in response to an instruction of a driving route, a GNSS feed, a video feed, and a LiDAR feed,
assigning a first set of the autonomous vehicles to pick up a first group of the participants at a first pick-up location, and
generating a transportation itinerary for the motorcade including a first driving route to the destination location from the first pick-up location and a first estimated travel time of the first driving route; and
starting the motorcade session, wherein the motorcade session includes the server:
establishing secure communication links with the autonomous vehicles in the motorcade and sending the transportation itinerary to the autonomous vehicles within the motorcade; and
facilitating, by the server, coordinated control within the motorcade of at least one of an integrated navigation function, an integrated communication function, and an integrated multimedia function,
wherein the facilitating of the coordinated control further includes the server processing data associated with at least one autonomous vehicle within the motorcade and communicating with at least one other autonomous vehicle within the motorcade based on the processed data.

2. The computer-implemented method of claim 1, wherein the server facilitating coordinated control of the integrated navigation function includes:
receiving data from a first autonomous vehicle within the motorcade indicating an updated traffic pattern at the location of the first autonomous vehicle;
processing the data and updating the transportation itinerary for the motorcade based on the processed data; and
sending an updated transportation itinerary to the other autonomous vehicles within the motorcade, wherein the updated transportation itinerary includes an updated driving route or an updated estimated travel time of the driving route.

3. The computer-implemented method of claim 1, wherein the initializing of the motorcade session further includes:
assigning a second set of the autonomous vehicles to pick up a second group of the participants at a second pick-up location,
wherein the generated transportation itinerary further includes a second driving route to the destination location from the second pick-up location and a second estimated travel time of the second driving route; and
determining, based on the first estimated travel time of the first driving route and the second estimated travel time of the second driving route, a first pick-up time for the first set of autonomous vehicles at the first pick-up location and a second pick-up time for the second set of autonomous vehicles at the second pick-up location such that an estimated first arrival time of the first set of autonomous vehicles at the destination location and an estimated second arrival time of the second set of autonomous vehicles at the destination location are within a pre-defined window of time duration.

4. The computer-implemented method of claim 3, wherein the first pick-up time for the first set of autonomous vehicles occurs earlier than the second pick-up time for the second set of autonomous vehicles, and the server facilitating coordinated control of the integrated navigation function includes:
receiving data from a first autonomous vehicle within the first set of autonomous vehicles indicating an extension of the first estimated travel time of the first driving route, wherein the extended first estimated travel time of the first driving route results in an updated first arrival time at the destination location such that the updated first arrival time occurs outside of the pre-defined window of time duration;
updating the transportation itinerary for the motorcade based on the processed data, including updating the second pick-up time at the second pick-up location such that the updated first arrival time and an updated second arrival time are within the pre-defined window of time duration; and
sending the updated transportation itinerary to the autonomous vehicles within the motorcade.

5. The computer-implemented method of claim 1, wherein the server facilitating coordinated control of the integrated navigation function includes:
receiving, at a server, a transportation itinerary update request, wherein the transport itinerary update request includes an updated destination location;
updating the transportation itinerary based on the transportation itinerary update request, including updating respective driving routes and respective estimated travel times of the respective updated driving routes based on a current location of the autonomous vehicles; and
sending the updated transportation itinerary to the autonomous vehicles within the motorcade, wherein at least one autonomous vehicle within the motorcade is re-routed to the updated driving route to the updated destination location based on the updated transportation request.

6. The computer-implemented method of claim 5, wherein at least one autonomous vehicle within the motorcade is instructed, by the server or a participant in the motorcade, to ignore the updated driving route to the updated destination location and remain on an existing driving route to the destination location.

7. The computer-implemented method of claim 1, wherein the server facilitating coordinated control of the integrated communication function includes:
receiving, at a server, a participant direct message received from a user interface of an autonomous vehicle within the motorcade, wherein the participant direct message includes at least one of text data, image data, audio data, or video data; and
sending, by the server to the autonomous vehicles within the motorcade, the participant direct message to enable the autonomous vehicles within the motorcade to present the participant direct message via respective user interfaces of the autonomous vehicles within the motorcade.

8. The computer-implemented method of claim 7, further including sending, by the server to the end user application operating on a user device associated with a participant in any particular autonomous vehicle within the motorcade, the participant direct message to enable the end user application to present the participant direct message via the user device associated with the participant.

9. The computer implemented method of claim 1, wherein the server facilitating coordinated control of the integrated communication function includes:
receiving, at a server, a participant direct message received the end user application operating on a user device associated with a participant in any particular autonomous vehicle within the motorcade, wherein the participant direct message includes at least one of text data, image data, audio data, or video data; and
sending, by the server to the autonomous vehicles within the motorcade, the participant direct message to enable the autonomous vehicles within the motorcade to present the participant direct message via respective user interfaces of the autonomous vehicles within the motorcade.

10. The computer-implemented method of claim 1, wherein the integrated communication function includes a live calling feature including the server facilitating real time or near-real time streaming of live audio or a live video across at least two of the autonomous vehicles within the motorcade.

11. The computer-implemented method of claim 1, wherein the server facilitating coordinated control of the integrated multimedia function includes:
receiving, from a participant via either a user interface in an autonomous vehicle within a motorcade or the end user application operating on a user device associated with the participant, media content capable of being presented on a user interface of the autonomous vehicles within the motorcade; and
sending, by the server to the autonomous vehicles within the motorcade, data enabling the autonomous vehicles to present the media content via the respective user interfaces of the autonomous vehicles within the motorcade;
wherein the media content includes one or more of audio data, video data, image data, or interactive entertainment data.

12. The computer-implemented method of claim 1, wherein the server facilitating coordinated control of the integrated multimedia function includes:
streaming, to the autonomous vehicles within the motorcade, a media content stream enabling the autonomous vehicles to present the media content stream via respective user interfaces of the autonomous vehicles within the motorcade;
receiving, from a participant via either a user interface in an autonomous vehicle within a motorcade or the end user application operating on a user device associated with the participant, a user input related to the media content stream including:
a playback command, a command to terminate the media content stream, a command to switch from the media content stream to a new media content stream, an input command to take an action within an interactive feature or gaming feature of the media content stream, or a reaction input indicating a particular emotive reaction based on the media content stream; and
sending, to the autonomous vehicles within the motorcade, an update to the media content stream based on the user input.

13. The computer-implemented method of claim 1, wherein the server facilitating coordinated control of the integrated multimedia function includes:
streaming, to a particular autonomous vehicle within the motorcade, a first media content stream enabling the particular autonomous vehicle to present the first media content stream via a user interface of the particular autonomous vehicle;
streaming, to another particular autonomous vehicle within the motorcade, a second media content stream enabling the other particular autonomous vehicle to present the second media content stream via a user interface of the other particular autonomous vehicle;
receiving, from the particular autonomous vehicle, a request to switch from the first media content stream to the second media content stream; and
streaming, to the particular autonomous vehicle, the second media content stream enabling the particular autonomous vehicle to present the second media content stream, in real time or near-real time synchronization with the other particular autonomous vehicle, via the user interface of the particular autonomous vehicle.

14. The computer-implemented method of claim 1, wherein the server facilitating coordinated control of the integrated multimedia function includes:
sending, to the autonomous vehicles within the motorcade, data controlling an aesthetic feature of the respective autonomous vehicles within the motorcade to synchronize the aesthetic feature across the motorcade, wherein the aesthetic feature is an external or internal lighting display parameter.

15. A system for coordinating multiple autonomous vehicles for group transportation, the system including:
a server, including:
a central dispatch logic to receive a motorcade formation request, initialize a motorcade session based on the motorcade formation request, wherein initializing the motorcade includes determining autonomous vehicles for use in the motorcade and generating a transportation itinerary for the motorcade, and update the transportation itinerary based on updated data associated with an autonomous vehicle within the motorcade,
a secure communication interface to facilitate bi-directional communication with the autonomous vehicles within the motorcade, and
a coordinated control logic to facilitate coordinated control of an integrated function across the autonomous vehicles within the motorcade including processing data associated with at least one autonomous vehicle within the motorcade and communicating with at least one other autonomous vehicle within the motorcade based on the processed data; and
a motorcade including a plurality of autonomous vehicles, each autonomous vehicle within the motorcade further including:
an end-to-end autonomous driving model to autonomously operate actuation signals of the vehicle in response to an instruction of a driving route, a GNSS feed, a video feed, and a LiDAR feed,
a secure communication logic to bi-directionally communicate with the server,
a multimedia content presentation logic to present media content to participants using the motorcade,
a user interface to receive user input for participant direct messaging and display participant direct messages received by the secure communication logic, display the media content presented by the multimedia content presentation logic, and receive user input for interacting with the presented media content,
an external programmable LED lighting display, and
an internal programmable LED lighting display.

16. The system of claim 15, wherein the server facilitates coordinated control of an integrated navigation function, the coordinated control of the integrated navigation function including:
the coordinated control logic processing updated navigation data, received by the secure communication interface from a first autonomous vehicle within the motorcade;
the central dispatch logic updating the transportation itinerary based on the updated navigation data; and
the secure communication interface sending an updated transportation itinerary to the other autonomous vehicles within the motorcade, wherein the updated transportation itinerary includes an updated driving route or an updated estimated travel time of the driving route.

17. The system of claim 15, wherein the server facilitates coordinated control of an integrated communication function, the coordinated control of the integrated communication function including:
receiving, by the secure communication interface, a participant direct message received from a user interface of an autonomous vehicle within the motorcade, wherein the participant direct message includes at least one of text data, image data, audio data, or video data; and
sending, by the secure communication interface to the autonomous vehicles within the motorcade, the participant direct message to enable the autonomous vehicles within the motorcade to present the participant direct message via respective user interfaces of the autonomous vehicles within the motorcade.

18. The system of claim 15, wherein the server facilitates coordinated control of an integrated multimedia function, the coordinated control of the integrated multimedia function including:
streaming, to the autonomous vehicles within the motorcade, a media content stream enabling the respective multimedia content presentation logics of the autonomous vehicles to present the media content stream via the respective user interfaces of the autonomous vehicles within the motorcade;
receiving, from a participant via either the user interface or an end user application operating on a user device associated with the participant, a user input related to the media content stream including:
a playback command, a command to terminate the media content stream, a command to switch from the media content stream to a new media content stream, an input command to take an action within an interactive feature or gaming feature of the media content stream, or a reaction input indicating a particular emotive reaction based on the media content stream; and
sending, to the autonomous vehicles within the motorcade, an update to the media content stream based on the user input.

19. A non-transitory computer readable storage medium impressed with computer program instructions that, upon executed on a processor, implement a method comprising:
receiving, at a server, a motorcade formation request from an end user application operating on a first user device, wherein the motorcade formation request includes a quantity of participants in the motorcade, at least one pick-up location, and a destination location;
initializing a motorcade session, by the server, based on the motorcade formation request, the initializing of the motorcade session including:
determining a quantity of autonomous vehicles for use in the motorcade based on the quantity of participants in the motorcade, wherein each autonomous vehicle further includes an end-to-end autonomous driving model to autonomously operate actuation signals of the vehicle in response to an instruction of a driving route, a GNSS feed, a video feed, and a LiDAR feed, assigning a first set of the autonomous vehicles to pick up a first group of the participants at a first pick-up location, and
generating a transportation itinerary for the motorcade including a first driving route to the destination location from the first pick-up location and a first estimated travel time of the first driving route; and
starting the motorcade session, wherein the motorcade session includes the server:
establishing secure communication links with the autonomous vehicles in the motorcade and sending the transportation itinerary to the autonomous vehicles within the motorcade; and
facilitating, by the server, coordinated control within the motorcade of at least one of an integrated navigation function, an integrated communication function, and an integrated multimedia function,
wherein the facilitating of the coordinated control further includes the server processing data associated with at least one autonomous vehicle within the motorcade and communicating with at least one other autonomous vehicle within the motorcade based on the processed data.

20. The non-transitory computer readable storage medium of claim 19, wherein the server facilitating coordinated control of the integrated navigation function includes:
receiving data from a first autonomous vehicle within the motorcade indicating an updated traffic pattern at the location of the first autonomous vehicle;
processing the data and updating the transportation itinerary for the motorcade based on the processed data; and
sending an updated transportation itinerary to the other autonomous vehicles within the motorcade, wherein the updated transportation itinerary includes an updated driving route or an updated estimated travel time of the driving route.
